(19) United States
(12) Patent Application Publication
(10) Pub. No.: US 2026/0091367 A1
(43) Pub. Date: Apr. 2, 2026

(54) DEHUMIDIFYING HYDROGEL WITH NANOMATERIALS

(71) Applicant: Pact Fuel, LLC, Darien, CT (US)

(72) Inventor: Juzer Jangbarwala, Chino Hills, CA (US)

(21) Appl. No.: 19/347,228

(22) Filed: Oct. 1, 2025

Related U.S. Application Data
(60) Provisional application No. 63/702,007, filed on Oct. 1, 2024.
(60) Provisional application No. 63/771,484, filed on Mar. 13, 2025.
(60) Provisional application No. 63/771,500, filed on Mar. 13, 2025.
(60) Provisional application No. 63/773,245, filed on Mar. 17, 2025.
(60) Provisional application No. 63/773,258, filed on Mar. 17, 2025.

(51) Int. Cl. B01J 20/28; B01D 53/26; B01J 20/20; B01J 20/26; B01J 20/32; B01J 20/34

(52) U.S. Cl. CPC B01J 20/28047; B01D 53/263; B01J 20/205; B01J 20/26; B01J 20/28059; B01J 20/28061; B01J 20/28085; B01J 20/324; B01J 20/3441; B01D 2252/205; B01D 2257/80

(57) ABSTRACT

A self-supporting dehumidifying porous material is comprised of a backbone polymeric matrix optionally with graphitic nanomaterials dispersed throughout. The backbone polymeric matrix can be a reversible hydrogel. The macroporous material can be used as a dehumidifying material for reducing energy consumption in air conditioning/climate control units. Common graphitic nanomaterials are electrically conductive, such as conductive carbon nanoparticles, carbon nanotubes, or graphitic nanofibers.

### CROSS-REFERENCE TO RELATED APPLICATIONS

The present application claims the benefit of and priority, under 35 U.S.C. § 119, to U.S. Provisional Application Ser. No. 63/702,007, filed Oct. 1, 2024, entitled “DEHUMIDIFYING NANOMATERIAL,” U.S. Provisional Application Ser. No. 63/771,484, filed Mar. 13, 2025, entitled “MACROPOROUS RESIN-CONTAINING HYDROGEL AND NANOMATERIALS,” U.S. Provisional Application Ser. No. 63/771,500, filed Mar. 13, 2025, entitled “DEHUMIDIFYING MATERIAL COMPRISING HYDROGEL-COATED HYDROPHOBIC PARTICULATES,” U.S. Provisional Application Ser. No. 63/773,245, filed Mar. 17, 2025, entitled “METHOD AND SYSTEM FOR EXTRACTING WATER FROM AIR,” U.S. Provisional Application Ser. No. 63/773,258, filed Mar. 17, 2025, entitled “POLYMERIC MACROPOROUS RESINS CONTAINING HYDROGEL AND NANOMATERIALS,” the entire disclosures of which is hereby incorporated herein by reference, in their entirety, for all that they teach and for all purposes.

### FIELD

This disclosure relates generally to a composite material comprised of a hydrogel supported on a porous substrate which can be directed to dehumidifying applications.

### SUMMARY

These and other needs are addressed by the various embodiments and configurations of the present disclosure.

In aspects of the disclosure, a dehumidifying material can include a reversible hydrogel material that is capable of absorbing water by forming bonds with water molecules from moisture-containing air and of releasing at least a fraction of the absorbed water upon being subjected to an electrical current.

In aspects of the disclosure, a dehumidifying material can include a hydrophobic porous substrate having immobilized thereon a reversible hydrogel material that is capable of absorbing water by forming bonds with water molecules from moisture-containing air and of releasing at least a fraction of the absorbed water upon being subjected to a change in temperature.

In aspects of the disclosure, a dehumidifying macroporous material can include a cross-linked polymer, the material having immobilized thereon a reversible hydrogel macroporous material that is capable of absorbing water by forming bonds with water molecules from moisture-containing air and of releasing at least a fraction of the absorbed water upon being subjected to a suitable stimulus.

In aspects of the disclosure, a dehumidification system can include:
a housing comprising an interior volume and an input for moist air and an output for dehumidified air; and
a plurality of plates positioned side-by-side in the interior volume of the housing, each of the plurality of electrically conductive plates comprising at least one layer of a hydrogel-containing material, the hydrogel-containing material comprises electrically conductive nanomaterials having immobilized thereon a reversible hydrogel that is capable of absorbing water by forming bonds with water molecules and of releasing at least a fraction of the absorbed water upon being heated above a critical temperature.

The hydrogel can be selected from the group consisting essentially of poly(vinyl methyl ethers); N,N-Diethyl acrylamide copolymers; acrylamides (N-alkyl or N-alkalene substituted); methacrylamides, such as poly(methacrylamideopropyl-methoammoniumchlorides); poly(acrylamide), poly(N-methylacrylamide), poly(N-ethylacrylamide), poly(cyclopropylacrylamide), poly(N-isopropylacrylamide), poly(methacrylamide), poly(N-methylmethacrylamide), poly(cyclopropylmethacrylamide), poly(N-isopropylmethacrylamide), poly(dimethylacrylamide), poly(N,N-dimethylaminopropylacrylamide, poly(N-methyl-N-ethylacrylamide), poly(N-methyl-N-isopropylacrylamide), poly(N-methyl-N-ethylacrylamide), poly(N-methyl-N-isopropylacrylamide), poly(N-methyl-N-n-propylacrylamide), poly(N,N-diethylacrylamide) poly(N-acryloylpyrrolidine), poly(N-acryloylpiperidine), poly(N-acryloylmethylhomopiperidine), poly(N-acryloylmethylpiperidine), and poly(N-acryloylmethylpiperidine) and wherein the hydrogen is cross-linked.

The substrate can have a mean, median, and/or mode pore size of at least about 200 microns, a porosity ranging from about 10 to about 60%, a pore volume of from about 0.01 to about 1 cm³/g, and a BET surface area of from about 20 to about 400 m²/g, a thermal conductivity of from about 50 to about 330 W/m*° K, and an electrical conductivity of at least about 0.1×10² S m⁻¹ (at 298-1150 K). The substrate can include one or more of a ceramic material, glass-containing material, microporous resin, activated carbon, graphite, and graphitic carbon black combinations and composites thereof.

Any of the above dehumidifying materials can optionally include an electrically conductive nanomaterial intermixed with the reversible hydrogel material. The reversible hydrogel material can be immobilized on the surface of the nanomaterial. The nanomaterial can have a surface area ranging from about 5 to about 4,000 m²/g, an average length of about 0.5 to about 10 microns and an average width of about 40 to about 60 nanometers, a thermal conductivity (at 50° C.) between about 0.04 to about 0.8 W/m*° K, and an electrical resistivity (at 20° C.) of from about 200 to about 300 ohm*cm.

The nanomaterial intermixed with the reversible hydrogel material can form a layer supported by the substrate. The thickness of the layer can be from about 0.01 to about 1000 microns, and the substrate can include silicon carbide-containing particles. The layer can coat from about 5 to about 85% of the area of the substrate. The layer can include from about 10 to about 75% wt. nanomaterial.

Graphitic nanomaterials, particularly graphitic nanofibers and/or nanotubes, impregnated with hydrogels, or hydrogels impregnated with graphitic nanofibers and/or nanotubes can exhibit highly advantageous properties for dehumidification applications. The relatively high surface area to volume ratio can provide pore sizes facilitating deposition of nanometer sized hydrogel particles, which, in turn, results in faster kinetics for absorbing and controllably releasing water molecules.

Nanomaterials dispersed in the hydrogel-containing material can provide structural strength and enable reversal of the hydrogel by passage of an electrical current. Higher structural strength allows repeated swelling from water adsorption and collapse from water desorption without substantial loss of structural integrity. As will be appreciated, hydrogels can be strengthened by dispersing graphitic nanofibers throughout the hydrogel matrix or volume. Addition of nanomaterials can allow repeated swelling and collapse of the hydrogel without losing integrity, which can be important for effective operation.

The composite porous dehumidifying material can reduce the energy consumption of an air cooling or air conditioning device by pre-treating the air to be conditioned with a universally applicable water extraction device that can reversibly extract water from a moisture laden air source, at ambient temperatures up to the lower critical solution temperature (LCST) of the hydrogel used, and at high space velocities sufficient to satisfy commercial HVAC equipment air flow rates. The extraction media should perform without using any significant amount of energy for regeneration. As is well known in the field of HVAC and air conditioning, humidity reduction in ambient air reduces the energy required for conditioning the air for comfort and process. The composite porous dehumidifying material having immobilized hydrogel polymer utilized for water extraction can also be regenerable by use of waste heat generated by the air conditioning or cooling mechanism. Its performance is repeatable for multiple cycles, the number of which can be determined on commercial evaluations of the intended device.

The composite porous dehumidifying material can have other advantages. The adsorption-desorption technology can provide for storage of energy, to be used either for heating and cooling and therefore offers manifold applications in various domains of cooling, heating, and dehumidification. The composite porous dehumidifying material can use less energy to dry air and regenerate (as regeneration or water removal can be done without expanding the latent heat of phase change), reduce the price of HVAC systems compared to conventional zeolite-based and activated carbon-based systems, be more efficient than current zeolite-based and activated carbon-based systems, and also have a smaller carbon footprint than current zeolite-based systems. Compared to such adsorbents, the composite porous dehumidifying material can provide not only high mechanical strength but also chemical stability and repeatable utilization.

The dehumidification system differs substantially from conventional dehumidification systems. Conventional methods of air conditioning and dehumidification, such as compression and the use of desiccants, are inefficient and cause copious amounts of unnecessary greenhouse gas emissions. The system of the present disclosure relates to the use of reversible hydrogels. A difference between the hydrogel system of the present disclosure and a desiccant system is that in order for the hydrogel to disgorge the liquid trapped in its network, it needs to be subjected to only a small external stimulus, such as being heated to only a temperature slightly above its critical point, not to the boiling point of water, as is the case with desiccants. The hydrogel undergoes a rapid and reversible, discontinuous phase transition by collapsing and disgorging liquid water. On the other hand, a desiccant absorbs water vapor and traps it as a liquid but can only be regenerated by driving the liquid water off as vapor, by creating a high vapor pressure zone on the surface of the desiccant with relation to the surrounding air vapor pressure, thus releasing moisture to the heated, low relative humidity air of regeneration. The hydrogel system of the present disclosure, by contrast, traps water vapor by actually forming hydrogen bonds and polar interactions, reacting with the vapor, and acting as a liquid. During regeneration, the hydrogen bonds are broken by the flow of electrons through the hydrogel causing the hydrogel to disgorge liquid water and not requiring any phase change of water. The energy savings in this manner and the reduced load on the air conditioning system for cooling the dehumidified air are very significant.

The composite porous dehumidifying material can be used as a filtration unit positioned upstream of an evaporative cooling system to reduce the humidity of the air and thereby increase the efficiency of the evaporative cooling system. The extracted water can be used by the evaporative cooling system to evaporatively cool the air. The size of the evaporative cooling system can thereby be decreased when compared to an evaporative cooling system in the absence of the composite porous dehumidifying material.

The composite porous dehumidifying material can extract potable water from air for human consumption. By way of illustration, a solar powered water dispenser comprising the composite porous dehumidifying material and a device to cause air flow in response to a differential pressure, such as a fan, air compressor, and the like. The passage of air through the composite porous dehumidifying material causes latent moisture to collect on the composite porous dehumidifying material, which is periodically removed from the material by passage of an electric current generated by the solar cells and/or batteries in electrical communication with the solar cells. An air purification unit, such as comprising an activated carbon or zeolite media, can be positioned upstream of the composite porous dehumidifying material to remove airborne contaminants to provide clean water. A demister can be used to remove aerosols or droplets from the inputted air, such as the aerosols or droplets from a nearby saltwater source.

These and other advantages will be apparent from the disclosure of the disclosure contained herein.

As used herein, “at least one” , “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Activated carbon” is a form of carbon commonly used to filter contaminants from water and air, among many other uses. It is processed (activated) to have small, low-volume pores that greatly increase the surface area available for adsorption or chemical reactions. As will be appreciated, adsorption, not to be confused with absorption, is a process where atoms or molecules adhere to a surface). The pores can be thought of as a microscopic “sponge” structure.

A “ceramic” is typically a hard, inorganic, solid material that can be heated treated into a desired shape and size. It has a high strength, hardness, durability, and resistance to heat and chemicals. Ceramics are compounds of metal, non-metal, or metalloid atoms.

Typically, a ceramic is an inorganic, metallic oxide, nitride or carbide, material. Other ceramic formulations are known to those of skill in the art.

“Glass Beads” are primarily composed of silicon oxide (SiO₂) and can be formed or molded into various spherical and non-spherical shapes. Common glass, such as soda-lime glass consists essentially of silica, lime, and soda or sodium carbonate with typical proportions being from about 60-75% silica, 12-18% soda, and 5-12% lime. Other types, like borosilicate glass (Pyrex) and lead glass incorporate different metal oxides (boric oxide or lead oxide, respectively) to achieve specific properties like heat resistance or brilliance. Other glass formulations are known to those of skill in the art.

“Graphite” is a naturally occurring or synthetic crystalline allotrope of carbon known for its metallic luster and high electrical and thermal conductivity. Its atoms are typically arranged in layers of hexagonal rings.

“Graphitized carbon black” or GCB is a high-temperature-treated carbon material that can retain and separate compounds, particularly non-polar organic molecules. It is created by heating conventional carbon black to very high temperatures (around 3000° C.) to form highly ordered, graphitic carbon structures with a relatively homogeneous, non-porous surface.

A macropore is a pore on a surface of or within a material having an average internal width of about 50 nm or larger.

A mesopore is a pore on a surface of or within a material having an average internal width of from about 2 nm to about 50 nm.

A micropore is a pore on a surface of or within a material having an average internal width about 2 nm or smaller.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

“Silicon carbide” has the formula SiC, also known as carborundum, is a hard chemical compound containing silicon and carbon. While silicon carbide can include impurities and added compounds to realize desired properties, it is primarily composed of silicon and carbon. It is a wide bandgap semiconductor that can naturally occur as moissanite. Grains of silicon carbide can be bonded together by sintering to form very hard ceramics. Large single crystals of silicon carbide can be grown by the Lely method.

Unless otherwise noted, an expression that a substance or material, regardless of phase, comprises or includes a particular element in the Periodic Table of Elements, such as carbon, nitrogen, hydrogen, and oxygen, is to be construed to include the element not only in its elemental form but also any other form of the element, including ions of the element and compounds and other molecules comprising the element.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a dehumidification system according to at least one embodiment of the present disclosure;

FIG. 2 is a block diagram of a dehumidification system according to at least one embodiment of the present disclosure;

FIG. 3 is a side view of a portion of the dehumidification system of FIG. 2; and

FIG. 4 is a partially disassembled perspective view of the dehumidification system of FIG. 2.

### DETAILED DESCRIPTION

In some embodiments, the present disclosure is directed to a composite porous dehumidifying material comprised of a porous (and in some applications permeable and thermally and electrically conductive) substrate comprising a continuous or discontinuous layer of a reversible hydrogel material. The reversible hydrogen material may be impregnated with nanomaterials, which have immobilized thereon the reversible hydrogel material that is capable of absorbing water from moisture-containing air, and which is capable of releasing at least a fraction of the absorbed water upon being subjected to an external stimulus. The external stimulus is selected from a temperature change, pH change, electric field, light intensity and wavelength, pressure change, and ionic strength change. Common external stimuli are low energy input, such as waste heat or a flow of electrical current.

The optional conductive carbon nanomaterial can be dispersed in and throughout the reversible hydrogel material for more effective adsorption and desorption of water vapor. The typical hydrogel system adsorbs water vapor by actually forming hydrogen bonds and polar interactions. The hydrogel can be thought of deliquescing when it absorbs moisture from moisture-containing air. That is, it forms bonds with water molecules and resembles a liquid. Hydrogels can be efficiently and effectively regenerated by water desorption when heated at or above their critical temperature (e.g., the lower critical solution temperature or LCST). The typical hydrogel can disgorge the liquid trapped in its network in response to only a small external stimulus, such as being heated to a temperature only slightly above its critical point. The hydrogel undergoes a rapid and reversible, discontinuous phase transition by collapsing and disgorging liquid water. During regeneration, the hydrogel disgorges the liquid water without any phase change of water.

The optional nanomaterial is primarily comprised of electrically conductive nanomaterials, which are typically graphitic. The nanomaterial is commonly comprised of electrically conductive graphitic nanomaterials, such as graphitic nanofibers, single-or multi-walled conductive carbon nanotubes, conductive carbon nanoparticles, and other conductive nanomaterials. Other allotropes of carbon may be employed.

In some applications, an amount of a reversible hydrogel is immobilized on the nanomaterials in an effective amount to maintain the porosity of the substrate during its swollen state. The nanomaterials can be affixed to or impregnated on a porous, permeable, and conductive substrate in a density that can maintain the porosity and when applicable permeability of the substrate during the hydrogel swollen state. In some applications, the hydrogel-containing material continuously or discontinuously coats at least about 5%, more commonly at least about 10%, more commonly at least about 15%, more commonly at least about 20%, more commonly at least about 25%, more commonly at least about 30%, more commonly at least about 35%, more commonly at least about 40%, more commonly at least about 45%, more commonly at least about 50%, and even more commonly at least about 55% of the surface area of the substrate. The deposition density of the nanomaterials on the substrate typically ranges about 0.1 to about 85%, more typically from about 0.5 to about 65%, and more typically from about 1 to 50% of the surface of the substrate. The hydrogel on the nanomaterials can be regenerated in situ simply by application of an external stimulus, such as an electric current or heating the material to the Lower Critical Solution Temperature or LCST. The reversible hydrogels utilized in the present disclosure undergo discontinuous volume phase transition behavior. They can be comprised of a single polymer that meets both the sorptive and regenerative requirements. An exemplary material is NIPA (poly-N isopropylacrylamide). It may also have multiple polymers, such as an absorptive component such as poly(methacrylamideopropyl-methoammoniumchloride) and an interpenetrating network of polymers as the regenerative component.

The composite porous dehumidifying material can include a macroporous substrate (such as macroporous silicon carbide bead, resin bead (such as a cross-linked polyacrylamide), glass bead, ceramic bead, activated carbon, graphite, carbon black, graphitic carbon black, and the like). The substrate can include embedded electrically conductive nanomaterials and a continuous or discontinuous coating of the reversible hydrogel, such as a cross-linked polyacrylamide, that may also include electrically conductive nanomaterials dispersed throughout the hydrogel.

The composite porous dehumidifying material can have any desired size or shape depending on the application.

### Hydrogel

Hydrogels are three-dimensional networks of cross-linked hydrophilic polymers that can become swollen, up to about 400% their original volume, when exposed to water, whether saline water or desalinated water. The typical hydrogel system adsorbs water vapor by actually forming hydrogen bonds and polar interactions. The hydrogel can be thought of as deliquescing when it absorbs moisture. That is, it forms bonds with water molecules and resembles a liquid. Hydrogels can be regenerated by water desorption when heated at or above their critical temperature (e.g., the lower critical solution temperature or LCST) or another external stimulus.

This sorbent polymer, or hydrogel, may be immobilized by either an interpenetrating polymer matrix (described below) or by reacting one part of the molecule with a reactive substrate, as in the case of the nanomaterials of the present disclosure. The sorption polymer is typically entrapped in a phase changing interpenetrating network of polymers, which operate in the critical temperature range of their phase diagram. The polymer network will contract above its design critical temperature, while it will expand if required by the water absorption of the absorption polymer, below its critical temperature. Hence, by design, if the critical temperature is above ambient temperature, the sorption polymer will react with water and will have room to accommodate the larger resulting molecule because the phase changing polymer network will expand. However, when the critical temperature is reached or passed, the phase change material contracts sharply, disgorging the absorbed water.

Any hydrogel may be employed. The reversible hydrogels commonly undergo discontinuous volume phase transition behavior. The hydrogel can be comprised of a single polymer that meets both the sorptive and regenerative requirements. The hydrogel will typically collapse by giving up at least a fraction of water absorbed under a trigger environmental condition, such as a specific range of temperature, for example a temperature range of about 60° to 80° C., and expands to up to about 400% of its original volume under a second trigger environmental condition, such as ambient temperature of about 15° to 50° C.

Exemplary hydrogels comprise poly(vinyl methyl ethers); N,N-Diethyl acrylamide copolymers; acrylamides (N-alkyl or N-alkalene substituted); methacrylamides, such as poly(methacrylamideopropyl-methoammoniumchlorides); poly(acrylamide), NIPA (poly-N isopropylacrylamide, poly(N-methylacrylamide), poly(N-ethylacrylamide), poly(cyclopropylacrylamide), poly(N-isopropylacrylamide), poly(methacrylamide), poly(N-methylmethacrylamide), poly(cyclopropylmethacrylamide), poly(N-isopropylmethacrylamide), poly(dimethylacrylamide), poly(N,N-dimethylaminopropylacrylamide, poly(N-methyl-N-ethylacrylamide), poly(N-methyl-N-isopropylacrylamide), poly(N-methyl-N-ethylacrylamide), poly(N-methyl-N-isopropylacrylamide), poly(N-methyl-N-n-propylacrylamide), poly(N,N-diethylacrylamide) poly(N-acryloylpyrrolidine), poly(N-acryloylpiperidine), poly(N-acryloylmethylhomopiperidine), poly(N-acryloylmethylpiperidine), poly(N-acryloylmethylpiperidine), poly(methacrylamideopropyl-methoammoniumchloride), N,N-Diethyl acrylamide copolymers, and blends and mixtures thereof. Polyacrylamide or PAM (with the formula (—CH₂CHCONH₂—) is commonly employed.

The reversible hydrogels utilized in the present disclosure undergo discontinuous volume phase transition behavior. They can be comprised of a single polymer that meets both the sorptive and regenerative requirements. An exemplary material is NIPA (poly-N isopropylacrylamide. It may also have multiple polymers, such as an absorptive component such as poly(methacrylamideopropyl-methoammoniumchloride) and an interpenetrating network of polymers as the regenerative component.

The hydrogels can be comprised of two primary components—at least one sorption polymer component capable of the sorption of water vapor into liquid in combination with a phase transition component comprised of two or more interpenetrating polymers. The hydrophilic poly(acrylamide) family of hydrogels can be copolymerized with hydrophobic esters of unsaturated polysaccharide derivatives (cyclodextrin acrylate/N-isopropylacrylamide) in varying proportions to increase the critical temperature of hydrogels.

At least one polymer of hydrogel material, commonly the sorption component, will be capable of reacting with vapor phase water wherein the hydrogel will expand in volume. The entire system will then be capable of deliquescing upon a given environmental change and give up water and shrink in volume. Once the sorption polymer has absorbed its capacity of moisture, or the polymer matrix has expanded to its limits, an external stimulus can reverse the conditions essentially regenerating the system. If the end of the absorption cycle has been reached due to the saturation of the reactive sites in the sorption polymer, an external stimulus such as an electronic perturbation via an electrical current, can reverse the reactivity and disgorge the water. If the capacity has been exhausted due to the expansion capability of the polymer network, then an external stimulus, such as rising temperature or also an electric current, makes the network go through a phase change and contract substantially, disgorging the water trapped in the sorption polymer due to change in conditions created by the severe contraction such as pressure. Hence, as a system, the sorption, and phase transition components expand as the sorbent absorbs water vapor, and disgorges the entrained liquid as result of an electrical current or as the temperature is raised by a small amount, such as by only about 10° to about 20° C. The energy needed to raise the local temperature of the hydrogel is provided by the porous substrate that can be made selectively less conductive by adding resistive materials, depending on the temperature rise desired. Non-limiting resistive materials that can be used in the practice of the present disclosure include the polymers of the hydrogel themselves.

The only thing required for the reversible hydrogels to deliquesce, then to release the absorbed water is that the ambient temperature be raised above their critical temperature, a point at which the phase transition network of the reversible hydrogels collapses, and there is severe contraction. This is achieved without the need to supply the latent heat of phase change required by desiccants. Conventional desiccants are commercially available for reducing the moisture content of ambient air intended for cooling or air conditioning. However, conventional desiccants require the heat of vaporization of water, or they need an unsaturated air stream at high temperature to regenerate. Reversible thermogels, in general, thus provide an ability to recover the water by use of only a relatively mild external stimulus. It will be understood that a hydrogel can be designed to respond to any one or more of these trigger external stimuli. Non limiting examples of reversible hydrogels that can used in the practice of the present disclosure include those disclosed in U.S. Pat. No. 4,074,039 which discloses N,N-Diethyl acrylamide copolymers and U.S. Pat. No. 4,828,710 that discloses a family of acrylamides (N-alkyl or N-alkalene substituted) and methacrylamides.

Water absorption is a function of saturation, so if the surface is saturated, the absorbed water from the surface must travel towards the center first before the surface can absorb more water. Such kinetics can be controlled by increasing the surface area of the gels, with very little depth needed for the water to travel. Similarly, if the gel is to be heated to trigger the release of water, one would notice a thermal insulation barrier between the heat source and the absorbed water. The very thin thickness achieved by the instant disclosure is in the nanometer range, thus increasing the kinetics by orders of magnitude. The reversible hydrogel material is typically immobilized on the nanomaterial in a form so thin that the absorbed water has very little distance to travel to the inner part of the hydrogel. The thickness of the hydrogel layer will typically be from about 0.01 to 1000 microns, commonly from about 0.01 to 500 microns, more typically from about 1 to 250 microns, more commonly from about 5 to 200 microns, and more typically from about 100 to about 200 microns. Further, space velocity is a value determined by dividing the volume of the absorption media by the volumetric flow rate of the gas containing the target component to be absorbed, in this case water vapor. It will be noted that the absorption kinetics of all families of hydrogel type polymers will be significantly improved by immobilizing them on the nanomaterial of the present disclosure commonly by in-situ polymerization or in situ crosslinking. The present disclosure provides a much larger surface area with an equivalent amount of volume compared to conventional hydrogel technology, thus increasing the speed at which water vapor can be absorbed.

A hydrogel that is thermally responsive at a temperature higher than its LCST, at which point it will release the moisture adsorbed and shrink can be prepared from the many suitable polymers known in the hydrogel art. Typically, these gels are water soluble until they are crosslinked. Non-limiting examples of such water soluble polymers include poly(acrylamide), poly(N-methylacrylamide), poly(N-ethylacrylamide), poly(cyclopropylacrylamide), poly(N-isopropylacrylamide), poly(methacrylamide), poly(N-methylmethacrylamide), poly(cyclopropylmethacrylamide), poly(N-isopropylmethacrylamide), poly(dimethylacrylamide), poly(N,N-dimethylaminopropylacrylamide, poly(N-methyl-N-ethylacrylamide), poly(N-methyl-N-isopropylacrylamide), poly(N-methyl-N-ethylacrylamide), poly(N-methyl-N-isopropylacrylamide), poly(N-methyl-N-n-propylacrylamide), poly(N,N-diethylacrylamide) poly(N-acryloylpyrrolidine), poly(N-acryloylpiperidine), poly(N-acryloylmethylhomopiperidine), poly(N-acryloylmethylpiperidine), and poly(N-acryloylmethylpiperidine). It will be noted that the exact composition of the hydrogels used in the practice of the present disclosure is not critical to achieve for the functional superiority provided by the present disclosure Any hydrogel can be used that will swell by absorbing moisture and that can reverse its swelling beyond its critical temperature, or by use of a relatively mild change of at least one environment condition.

The hydrophilic poly(acrylamide) family of hydrogels can be copolymerized with hydrophobic esters of unsaturated polysaccharide derivatives (cyclodextrin acrylate/N-isopropylacrylamide) in varying proportions to increase the critical temperature of hydrogels.

In one embodiment, Xanthan gum can be partially functionalized by esterification with maleic anhydride and copolymerized with a known temperature sensitive precursor (N-isopropylacrylamide) and water-swollen hydrogels with interpenetrating polymer networks (IPN) can be obtained. These copolymers will exhibit critical temperatures of 37° to 40° C., which is suitable for the present disclosure, and such similar combinations of polysaccharides and hydrogels can be appreciated by one of ordinary skill in the art.

In an embodiment of the disclosure, the hydrogel deposited on or affixed to the surface of the resin or substrate comprises a polyacrylamide or PAM (with the formula (—CH₂CHCONH₂), typically having a linear-chain structure. The PAM may be a copolymer or modified polymer. As will be appreciated, other water-absorbent polymers can be used, such as other polyolefins.

### Cross-linking Agent

Because PAM forms a gel when hydrated, the PAM is typically cross-linked using a hydrogel cross-linking agent, such as N,N-methylenebisacrylamide, polyethyleneimine (PEI), 1,3-propanediamine, 1,3-propanedithiol, dithiothreitol, dithioerythritol, 1,5-pentanediamine, hexamethylenediamine, diethylenetriamine, triethylenetetramine, propylenediamine, di(aminomethyl)ether, 1,8-diamino-4-(aminomethyl)octane, xylylenediamine, hydroquinone, bisphenol A, bisphenol sulfone, 1,4-butanedisulfinic acid, benzenedisulfinic acid, thioethanolamine, p-aminothiophenol, and butylenediamine, chitosan, metal (e.g., Cr(III)), phenolic compounds and formaldehyde, L-lysine, and other monomer, oligomeric, or polymeric cross-linking agents known to those of skill in the art.

The hydrogel may be deposited at selected locations on the electrically conductive nanomaterials. This can be effected by depositing the cross-linking agent, initiator, and/or polymerization catalyst at the selected locations before contact with the hydrogel polymer precursor. As noted, the reversible hydrogel material can surround the nanomaterial in a form so thin that the absorbed water has very little distance to travel to the inner part of the hydrogel. The thickness of the hydrogel layer will typically be from about 0.01 to 1000 microns, commonly from about 0.01 to 500 microns, and more commonly from about 0.01 to 200 microns.

In other embodiments, structural integrity is imparted to the hydrogel during repeated water adsorption and desorption cycles by incorporating the nanomaterial into the hydrogel coating. In contrast to the prior embodiment in which the nanomaterial was the continuous phase or primary component, the hydrogel in the present embodiment is the continuous phase or primary component.

### Optional Nanomaterial

The optional nanomaterial is primarily comprised of electrically conductive nanomaterials, which are typically graphitic. The nanomaterials include electrically conductive carbon nanoparticles and nanofibers, such as graphitic nanofibers, single-or multi-walled conductive carbon nanotubes, conductive carbon nanoparticles, and other conductive nanomaterials. Other allotropes of carbon may be employed. Regarding properties, graphitic nanoparticles can exhibit unique properties such as high surface area, quantum confinement effects, and size-dependent optical and electronic properties.

In some embodiments, the nanomaterials are in the form of nanofibers that consist primarily or entirely of crystalline graphite. GNF can be crystalline or can contain an amorphous component. The crystalline graphite can be of different forms.

In some embodiments, the nanofibers primarily or entirely consist of platelet-type carbon nanofibers, in which the nanofibers comprise platelets that are aligned perpendicular to a major axis of the nanofiber. In some embodiments, the nanofibers primarily or entirely consist of herringbone nanofibers in which the graphene layers are stacked obliquely with respect to the major axis of the nanofiber. Herringbone-type nanofibers consist of a quasi-cylindrical arrangement which exhibits a hollow or an amorphous core surrounding the axis, while the outer part presents a very well-defined arrangement of parallel graphite layers. The GNF graphene layers are stacked as lamp-shade type or closed cones oriented in the growth direction and the formation of curved surface is determined by the occurrence of square or pentagonal carbon rings (ring defects) in the hexagonal network. In some embodiments, the nanofibers primarily or entirely consist of ribbon nanofibers in which the graphene layers are substantially parallel to the major axis. The various types of nanofibers may be mixed together in various ratios depending on the application.

The three forms can have excellent physical, electrical, and thermal properties when combined with hydrogels. Typically, at least most of the nanomaterials have a surface area ranging from about 10 to about 250 m²/gram and more typically from about 50 to about 200 m²/gram, and even more typically from about 50 to about 130 m²/gram. Aspect ratio can be important (width: length). In some embodiments, at least most of the nanomaterials are from about 40-60 nanometers in width and from about 0.5-10 microns in length. The fibers are typically substantially free of pores.

In comparison with a carbon nanotube (CNT), a graphitic nanofiber (GNF), in some applications, is a one-dimensional nanofiller consisting of a series of graphite planes stacked in the longitudinal direction of the fiber at an approximate angle of 25°. CNTs typically have a smaller diameter (less than about 50 nm and typically ranging from about 5 to about 15 nm) than GNFs (about 50 to about 200 nm), which increases the chemical reactivity of CNFs due to the exposure of active carbon atoms on the outer surfaces of nanofibers.

GNFs and CNTs can impart equivalent electrical conductivity to the conductive substrate at lower loadings compared to other conductive fillers and have relatively low thermal expansion. The thermal conductivity (at 50° C.) of at least most of the nanomaterials is commonly between about 0.04 to 0.80 W/m*° K and electrical resistivity (at 20° C.) is commonly about 200-300 ohm*cm. In embodiments, at least most of the GNF can, but is not required to, have (i) a nitrogen surface area from about 40 to 300 m²/g; (ii) an electrical resistivity of 0.4 ohm·cm to 0.1 ohm·cm; (iii) a crystallinity from about 95% to 100%; and (iv) a spacing between adjacent graphite sheets of 0.335 nm to about 1.1 nm, preferably from about 0.335 nm to about 0.67 nm, and more preferably from about 0.335 to about 0.40 nm.

At least most of the GNFs and CNTs will also commonly have a tensile strength of about 0.05 to about 0.30 N/m. The coefficient of thermal expansion (CTE) of the GNFs is typically less than about 100 ppm/° C.

The graphitic nanofibers can be synthesized in any method known to the art, such as using metal catalysts. Example catalysts can be iron (III) oxide and nickel (II) oxide, or nickel, iron, or cobalt catalysts. The catalysts can be synthesized ahead of time using any method known to the art. In embodiments, GNF is synthesized using chemical vapor deposition and metal oxide catalysts to grow GNF on the catalysts in the chamber. The temperature in the chamber, duration of heating, rate of gas flow, ratio of gas flow and catalyst all impact the final morphology of the graphitic structure. In embodiments, the GNF-synthesizing gases used are H₂ and C₂H₄. In embodiments, other gases known to be precursors for graphitic structures can be used. In embodiments, conditions are chosen to facilitate stacked platelets to form a fiber structure. In embodiments, supported catalysts are used. In embodiments, unsupported catalysts are used. In embodiments, other methods known to the art to synthesize graphitic nanofibers can be used. In embodiments, other morphologies besides stacked platelets perpendicular to a fiber axis can be synthesized and used.

The platelets can range in size from about 1 nanometer in diameter to about 1 micron in diameter. More commonly, the diameter of the platelets, and therefore the diameter of at least most of the GNF, can be from about 5 nm to about 500 nm, or even more commonly from about 50 nm to about 300 nm. The length of the fibers can be from about 20 nm to about 25 microns.

Surface area of at least most of the GNF can range from at least about 5 m²/g to at least about 4000 m²/g. More commonly, the surface area can range from about 10 m²/g to about 1000 m²/g, from about 15 m²/g to about 500 m²/g, or from about 20 m²/g to about 400 m²/g. Pore volume of the GNF can range from about 0.01 cm³/g to about 2 cm³/g. Other surface areas and pore volumes can be used based on the desired application for the final composite material.

The GNF can be hydrophilic or hydrophobic depending on the application.

The hydrogel-containing material will commonly have a carbon nanomaterial content between about 0 percent and 99.9 percent, more commonly between about 5 and about 85%, more commonly between about 10 and about 75%, more commonly between about 25 and about 80%, and more commonly between about 35 and about 70%. In some applications, the hydrogel-containing material will have a carbon nanomaterial content between about 90 percent and 99.9 percent, more commonly between about 95 and about 99%, and more commonly between about 98 and about 99.9%. In some applications, the hydrogel-containing coating has a carbon nanomaterial content between about 0 percent and 99.9 percent, more commonly between about 5 and about 75%, more commonly between about 10 and about 65%, more commonly between about 15 and about 55%, and more commonly between about 25 and about 50%.

In one embodiment, the nanomaterials can be pre-conditioned in a strong mineral acid such as nitric, sulfuric, or hydrochloric acid. The concentration of the mineral acid for such treatment is from about 0.5% by weight to 98% by weight, preferably from about 2 to about 20% by weight, and more preferably from about 5 and 10% by weight. The acid treatment will functionalize the edges of the graphite with —OOH and —OH groups. The functionalized nanomaterial surface can then be used to first immobilize a catalyst, an initiator, and/or a crosslinking agent as discussed more fully below.

### Substrate

The hydrogel-containing nanomaterials can be embedded on, impregnated on, or otherwise affixed to the (typically porous, permeable, and conductive) substrate.

In embodiments, the pore size can be chosen based on the swelling of the hydrogel and based on the desired application for the final composite material. In embodiments, the substrate can be microporous, mesoporous, macroporous, or any combination of the pore sizes. To reduce pressure losses over the substrate, the mean, median, and/or mode pore size of the substrate is typically at least about 2,000 microns, more typically at least about 1,000 microns, more typically at least about 500 microns, more typically at least about 200 microns and more typically ranges from about 100 to about 1,500 microns and more typically from about 500 to about 1,000 microns. In some applications, at least about 35% of the pores, more typically at least about 50%, and more typically at least about 75% of the pores have a pore size in the foregoing range. In some applications, the substrate has a porosity ranging from about 10 to about 60%, more typically from about 15 to about 50%, and more typically from about 20 to about 40%, and a pore volume ranging from about 0.01 to about 1 cm³/g, more typically from about 0.1 to about 0.75 cm³/g, and more typically ranging from about 0.2 to about 0.5 cm³/g. The substrate has a typical BET surface area of about 20 to 400 m²/g_{/}, more typically of from about 40 to 200 m²/g, and more typically of from about 40 to 150 m²/g.

While a hydrogel may be affixed to the substrate itself (in addition to the hydrogel on the nanomaterials) as set forth in U.S. Pat. No. 9,211,499, the substrate of the present disclosure itself is typically substantially free of hydrogel prior to deposition of the nanomaterials and, apart from the deposited hydrogel-containing nanomaterials, is typically substantially free of hydrogel after nanomaterial deposition.

In some applications, a porous, permeable, and conductive substrate in the form of a woven or nonwoven fiber substrate comprised electrically conductive fibers is employed. Although porous fibrous electrically conductive substrates are preferred, such as graphitic fibers, any other suitable fiber material can be used that can withstand the conditions of their intended use, such as in dehumidifying equipment, such as air conditioning systems and chillers. The porous substrate will preferably have a fiber content between about 70 percent and 99.9 percent, more preferably between about 90 and about 99.9%, and more preferably between about 98 and about 99.9%. The porous fibrous substrate is typically comprised of a graphitic fibers in a formed shape, such as a rectangular mat, disk, cylinder etc. The thermal conductivity (@50° C.) of the porous substrate is preferably between about 0.04 to 0.80 W/m*° K and will also preferably have a tensile strength of about 0.05 to about 0.30 N/m and an electrical resistivity (at 20° C.) of about 200-300 ohm*cm.

In some applications, a porous, permeable, and conductive substrate in the form of a bed of electrically conductive beads is employed. The beads typically have a particle size ranging from about 1 micrometer to about 10 mm, more typically about 5 micrometers to about 5 mm, more typically from about 10 micrometers to about 1 mm. Stated differently, the beads can have a particle size distribution ratio D₉₀/D₅₀ of no more than 2 and mor typically of no more than about 1.75.

In embodiments, the substrate is in the form of porous, polycrystalline, or monocrystalline silicon carbide-containing beads, fibers, or other shaped articles. Silicon carbide has several polymorphs, most notably α and β polymorphs. Each polymorph has a different crystal structure, thermal conductivity, and bandgap. In embodiments, the SiC used has a hydrophobic surface. In embodiments, the SiC used has a hydrophilic surface and is surface-treated by methods known to the art to have a hydrophobic surface. The hydrophilic SiC can be surface treated to have functional groups that make the surface hydrophobic. The hydrophilic SiC surface can be coated with a substance that makes the resulting product have a hydrophobic surface. Other methods known to the art to change the hydrophobicity of a surface can be applied to make the SiC have a hydrophobic surface.

In embodiments, α-SiC can be used. The α silicon carbide typically has a hexagonal crystal structure, a hardness on the Mohs scale of at least about 9.2, a high thermal conductivity from about 120 to about 330 W/mK, a low coefficient of thermal expansion typically of no more than about 5.0×10−6/° C., typically no more than about 4.8×10−6/° C., or typically no more than about 4.7×10−6/° C. along the c axis or typically no more than about 4.3×10−6/° C. along the a axis, perpendicular to the c axis (where the c axis is the longest edge of the crystal structure and the thermal coefficient is measured at 300K); and a wide bandgap typically of more than about 0 eV and no more than about 3 eV, a high chemical stability, a high thermal conductivity typically of at least about 4.0 W/(cm ° C.), at least about at least about 4.5 W/(cm ° C.), or at least about 4.9 W/(cm ° C.) (measured at 300K).

In embodiments, β-SiC can be used. The β silicon carbide typically has a cubic crystal structure, a hardness on Mohs scale of at least about 9.5, a high heat resistance of up to about 2,100° C. (changing to hexagonal or rhombohedral α silicon carbide at higher temperatures), a wide bandgap typically of more than about 0 eV and less than about 3 eV, a high chemical stability, a high thermal conductivity typically of at least about 50 W/mK, more typically at least about 75 W/mK, more typically of at least about 100 W/mK, more typically of at least about 150 W/mK, 250 W/mK, more typically of at least about 275 W/mK, and more typically of at least about 300 W/mK (measured at 300K), and a low coefficient of thermal expansion typically of no more than about 2.5 (10⁻⁶ ° K⁻¹) (measured at 300K). The substrate can have an electrical conductivity typically of at least about 0.1×10² S m⁻¹ (at 298-1150 K), more typically of at least about 0.25×10² S m⁻¹ (at 298-1150 K), more typically of at least about 0.5×10² S m⁻¹ (at 298-1150 K), more typically of at least about 0.75×10² S m⁻¹ (at 298-1150 K), and more typically of at least about 1×10² S m⁻¹ (at 298-1150 K). As will be appreciated, dopants may be added to increase the electrical resistivity of the silicon carbide.

The silicon carbide typically comprises no more than about 5 wt. %, more typically no more than about 2.5 wt. %, and more typically no more than about 1 wt. % free carbon, silicon dioxide, free silicon, aluminum oxide, magnesium oxide, and calcium oxide, individually and collectively.

In some embodiments, the substrate comprises at least about 95 wt. % silicon carbide of either polymorph, no more than about 1 wt. % free carbon, no more than about 2 wt. % silicon dioxide, no more than about 1 wt. % of each of free silicon, iron, aluminum oxide, magnesium oxide, and calcium oxide.

In embodiments, the purity of SiC can be chosen based on the desired properties. The purity of SiC can be at least about 3N (99.9%), or at least about 4N (99.99%). Trace elements in silicon carbide can include, but are not limited to, Na, Mg, Al, Ca, Ti, Cr, Mn, Fe, Ni, Cu, B, V, and Zr. Trace elements can commonly be present in typically no more than about 20 ppm, no more than about 15 ppm, no more than about 10 ppm, or no more than about 5 ppm. Other trace elements such as C, N, H, O, and other elements known to the art to be present in SiC can also be present in trace amounts.

In embodiments, SiC can be doped to alter the conductive properties. Possible doping elements include, but are not limited to, N, P, Be, B, Al, and Ga.

In embodiments, other materials known in the art with a bandgap of more than 0 eV and less than about 3 eV and a thermal conductivity of at least about 250 W/mK can be used.

In embodiments, the substrate is comprised of β-SiC. In embodiments, the substrate is comprised of α-SiC. In embodiments, the substrate is a conductive ceramic is a 3D porous network. In embodiments, the substrate is porous SiC. In embodiments, the SiC can be a foam. In embodiments, the SiC pore size can be primarily microporous, mesoporous, macroporous, or contain any combination of micro-, meso-, and macro-pores. The pore size can be chosen based on the desired application, and the substrate material can also be chosen based on the desired application.

In embodiments, SiC has a BET surface area of at least about 10 m²/g, more commonly at least about 15 m²/g, or even more commonly at least about 20 m²/g. In embodiments, the SiC can have a BET surface area of at least about 25 m²/g, at least about 30 m²/g, or at least about 40 m²/g.

In embodiments, the SiC substrate can be in any suitable shape, such as fibers, beads, or rods. The SiC substrate can have pores according to the application of the present disclosure. In embodiments, the SiC can be microporous. In embodiments, the SiC can be macroporous. In embodiments, the SiC can be macroporous.

As will be appreciated, SiC substrates beneficially are more thermally conductive than many other substrates and the hydrogel on the substrate can be regenerated in a vessel that is thermally jacketed. During regeneration of the composite porous dehumidifying material, the jacket would be heated to critical temperature (LCST) of the hydrogel, and the heat would be substantially uniformly transmitted by the silicon carbide substrate, thereby regenerating the hydrogel.

In embodiments, the substrate can be a porous and optionally permeable glass-containing beads, fibers, rods, or other shaped articles having suitable electrical and thermal conductivity properties noted above. Porous glass can be made through any method known to the art, including, but not limited to, metastable phase separation in borosilicate glass and liquid extraction, a sol-gel synthesis, or by sintering glass powder. The primary pore size of porous glass can be in the micropore, mesopore, or macropore range. More commonly, the glass has the pore size range noted above. Porous glass can have high thermal, mechanical, and chemical resistance. Porous glass can contain commonly at least about 90% silica, at least about 93% silica, and at least about 95% silica and more commonly about 96% silica. The rest of the porous glass can be comprised of sodium oxide (Na₂O) and/or boron oxide (B₂O₃). The porous glass, and any chosen substrate, can be comminuted as needed to the desired size in the application.

In embodiments, the substrate can be any ceramic bead, fibers (including as micro-or nanofibers), rod, or other shaped articles having suitable electrical and thermal conductivity properties noted above. Examples include, but are not limited to, molybdenum disilicate (MoSi₂), lanthanum chromite (LaCr₂O₄), zirconia (ZrO₂), tin oxide (SnO₂), and copper aluminum oxide (CuAlO₂). Any ceramic can be doped with other elements to enhance desired thermal and electrical conductivities for the substrate in the present disclosure.

In embodiments, porous, permeable, and conductive solid (non-fibrous) substrates, such as sintered and non-sintered porous metal and nonmaterial (e.g., bronze, stainless steel, Monel™, nickel, Hastelloy™, and titanium), graphitic fibers, ceramic fibers, and other metallic and semi-metallic fibers are employed.

In embodiments, the substrate can be other electrically conductive, hydrophobic substrates. Nonlimiting examples include carbon-based materials, such as activated carbon, carbon black, and graphite, and modified polymers, such as polyaniline (PANI) and poly(3,4-ethylenedioxythiophene (PEDOT) which can be made hydrophobic through surface modification, such as by doping with low surface energy molecules, surface texturing, or application of an external hydrophobic coating. Alternatively, a hydrophobic polymer, such as polyethylene and polytetrafluoroethylene (PTFE), can be made electrically conductive by application of an electrically conductive coating or dispersing conductive materials, such as nanomaterials and carbon nanofibers, into the polymeric matrix. As will be appreciated, hydrophobic materials repel water, thereby forcing the water to be absorbed by the hydrogel rather than the particulate substrate. In this manner, the substrate does not compete with the hydrogel for water attraction. The activated carbon can be any activated carbon having a relatively high strength to and porosity and permeability to maintain its structural integrity after repetitive adsorption-desorption cycles and provide low dust generation while maintaining a relatively low pressure drop. The graphite can be any crystalline allotrope of carbon that, like activated carbon, has a relatively high strength to and porosity and permeability to maintain its structural integrity after repetitive adsorption-desorption cycles and provide low dust generation while maintaining a relatively low pressure drop. The conductivity of the graphite is due to its many stacked layers of graphene. The allotropic form of graphite may be either alpha (hexagonal) or beta (rhombohedral).

The optional graphitic nanomaterials can be incorporated in the substrate to impart electrical conductivity. The substrate will commonly have a graphitic nanomaterial content between about 0 percent and 99.9 percent, more commonly between about 5 to about 99%, more commonly between about 25 and about 95%, more commonly between about 50 and 95%, more commonly between about 50 and about 85%, more commonly between about 65 and about 85%, and more commonly between about 75 and about 85%.

In some applications, activated carbon or graphite, carbon black, or graphitic carbon black is employed as a carbonaceous substrate for the hydrogel-containing material. The carbonaceous substrate commonly has an iodine absorption of at least about 500 mg/g, more commonly at least about 750 mg/g, more commonly at least about 850 mg/g and more commonly at least about 950 mg/g, a specific surface area of at least about 250 m²/g, more commonly at least about 300 m2/g, more commonly at least about 500 m²/g, more commonly at least about 750 m²/g, and more commonly at least about 900 m²/g but commonly no more than about 750 m2/g, and more commonly no more than about 1,000 m²/g, a hardness of at least about 75%, more commonly at least about 85%, and more commonly at least about 95% and an ash content of no more than about 5 wt. %. The pore structure of the carbonaceous substrate typically comprises at least about 50% macropores (e.g., a pore size of more than about 50 nm) and more typically at least about 65% macropores with the remainder being a combination of micropores (e.g., a pore size of no more than about 2 nm) and mesopores (e.g., a pore size ranging from about 2 to about 50 nm). The use of a larger pore size distribution can provide sufficient volume to accommodate swelling by the hydrogel during water adsorption cycles. A common feed material for the activated carbon comprises predominantly coconut shells.

In embodiments, the hydrogel can be embedded on, impregnated on, or otherwise affixed to a polymeric macroporous resin as the substrate. The polymeric macroporous resin can further comprise a, typically cross-linked, polymer. The polymeric matrix can optionally surround and encompass the nanomaterials, which are randomly dispersed throughout the matrix. The monomer forming the cross-linked polymer forming the polymeric matrix can comprise styrene, oxyethylene, oxypropylene, acrylate or acrylic compounds (e.g., methacrylic acid, methyl methacrylate, 2-hydroxyethyl methacrylate, glycidyl methacrylate, etc.), vinyl compounds (e.g., vinyl pyridine, vinylbenzylchloride, divinyl compounds (such as divinylbenzene or DVB, etc.), etc.), phenolic compounds, formaldehyde compounds, and mixtures and blends thereof. As will be appreciated, other polymers will be known to those of skill in the art.

In one application, the polymeric macroporous resin is formed by polymerizing the monomer in the presence of a cross-linking agent, such as divinylbenzene, p-xylylene-dichloride (XDC) and other vinylic compounds, 1,4-bis-chloromethyldimethyl ether (CMDP), monochlorodimethul ether (MCDE), dimethylformal (DMF), tris-(chloromethyl)-mesitylene (CMM), p,p′-bis-chloromethyl-1,4-diphenylbutane (DPB), and other monomer, oligomeric, or polymeric cross-linking agents known to those of skill in the art.

Typically, the polymeric macroporous resin is formed from styrene cross-linked with DVB to form a three-dimensional matrix or network of styrene-divinylbenzene copolymers.

The polymer in the polymeric microporous resin typically is functionalized while the hydrogel polymer typically is not. As will be appreciated, functionalized polymers have one or more chemical functional groups (e.g., polar or ionic functional groups) that are different from the polymer backbone change.

In embodiments, to manufacture the macro-porous beads, the cross-linking agent, optional nanomaterial, and monomer are combined in a suitable solvent or solvent mixture. One or more initiators and/or catalysts, such as ammonium persulfate and potassium persulfate (initiator), tetramethylenediamine, β-Dimethylaminopropionitrile and transition metal ions (accelerator, otherwise called catalyst), among others can be mixed into the solution to assist in cross-polymerization. Exemplary solvents include water, dimethyl sulfoxide or DMSO, an alcohol (e.g. tetradecanol, pentanol, and) benzyl alcohol, cyclohexane, dichloroethane, heptane, ethyl-2-hexanoic acid, a linear polymer such as polyethylene glycol, supercritical carbon dioxide, etc., and mixtures thereof. In some embodiments, a mixture of inert solvents, or a porogenic solvent, may be employed that solvate the polymer chains at least during the early stages of polymerization. In some applications, the solvent is substantially free of water. The cross-linking agent can be previously deposited by known techniques on the nanomaterial. Typically, the solvent or solvent mixture is selected so that the monomer is at least partially soluble while the cross-linking agent is substantially insoluble to maintain the cross-linking agent on the nanomaterial.

The polar solvent (e.g., porogen or inert diluents such as ethanol, propan-2-ol, N-methylpyrrolidone, chloroform, ethylene glycol, dimethylformamide, cyclohexanol and dodecan-1, and the like) is captured within the polyacrylamide. In some embodiments, the polar solvent is volatile and is thermally evaporated to form the macro-porous beads. As the volatile polar solvent escapes from the polymerized bead and evaporates, the solvent forms water-attractive micropores (e.g., nanopores) and interconnecting percolation tunnels for trapping water molecules to form a bead having a significantly higher level of porosity and permeability. In other embodiments, the polyacrylamide precipitates from the polar solvent to form a separate phase, one of which is the substantially pure solvent and the other the cross-linked polyacrylamide. After removal of the solvent by any suitable technique, a well-defined system of interconnected pores and channels (most of which have a pore size of more than 50 Angstroms) is preserved in the polyacrylamide. The substantially increased surface area of the bead (typically ranging from about 250 to about 1,000 m²/gram and more typically from about 300 to about 750 m²/gram) can provide higher water adsorption kinetics and water capacities and more effective dehumidification. Unlike traditional macro-porous resins, the polyacrylamide is typically not functionalized.

Any step-growth, condensation, addition, or chain-growth polymerization techniques may be employed, including without limitation emulsion polymerization (e.g., microchannel chip technique, drop break-off technique, and membrane emulsification), solution polymerization, suspension polymerization, dispersion polymerization, and jet polymerization.

After polymerization is substantially completed, the polar solvent can be removed by heating, drying, or displacement by dipping the particulate in an immiscible solution. In some embodiments, the polar solvent is volatile and is thermally evaporated. The surface area of the bead (typically ranging from about 250 to about 1,500 m²/gram and more typically from about 300 to about 1,350 m²/gram) can provide higher water adsorption kinetics and water capacities and more effective dehumidification. The polyacrylamide is typically not functionalized.

The porous polymer resin beads or other substrate can have any suitable shape, such as spherical or rod-shaped.

In embodiments, the mixture is polymerized by any suitable technique to form beads comprising randomly distributed nanomaterials.

### Synthesis of the Composite Porous Dehumidifying Material

In an embodiment of a process to form the composite porous dehumidifying material, the optional nanomaterial is placed in a vessel, such as a column or cartridge and treated with a wetting agent to make the fibers hydrophilic. The optional nanomaterial is then immersed in a dilute aqueous solution of the monomer of the reversible hydrogel. The solution is then exposed to a crosslinking agent, initiator, and/or catalyst such that the desired polymer forms on the surface of the nanomaterials. The amount or thickness of the immobilized hydrogel can be controlled by the concentration of the various components. It will be understood that the amount of hydrogel immobilized on the graphitic nanomaterial of the present disclosure will be an effective amount. That is, there needs to be enough hydrogel on the graphitic nanomaterial surface to effectively remove a predetermined amount of water from air in a predetermined amount of time. The amount and time may vary depending on the overall moisture content of the air and the size of the area to be dehumidified. There cannot be so much hydrogel on the nanomaterial and/or substrate to adversely affect the flow of air through the vessel. The amount of substrate surface that will be covered with hydrogel-containing nanomaterials (and directly deposited hydrogel on the substrate surface) in accordance with the present disclosure will typically range from about 0.1 to 50%, commonly from about 20 to 40%, and more commonly from about 25 to 35%. Thus, when choosing what polymers to use for the hydrogels of the present disclosure things such as low volume increase versus high water sorption need to be considered. High swelling could cause too much obstruction of the porosity of the porous and permeable substrate and needs to be avoided.

In another embodiment, the optional nanomaterials are conditioned in a strong mineral acid such as nitric, sulfuric, or hydrochloric acid. The concentration of the mineral acid for such treatment is from about 0.5% by weight to 98% by weight, commonly from about 2 to about 20% by weight, and more commonly from about 5 and 10% by weight. The acid treatment will functionalize the edges of the graphite with —OOH and —OH groups. The functionalized nanomaterial surface can then be used to first immobilize a sorptive component without the polymer network, catalyst, an initiator, or a crosslinking agent.

In another embodiment, the optional nanomaterials are contacted with the hydrogel cross-linking agent, such as by dipping or otherwise contacting the cross-linking agent with the surface of the nanomaterials. Exemplary cross-linking agents comprise N,N-methylenebisacrylamide, n,n′-bis(acryloyl) cystamine, polyethyleneimine (PEI), 1,3-propanediamine, 1,3-propanedithiol, dithiothreitol, dithioerythritol, 1,5-pentanediamine, hexamethylenediamine, diethylenetriamine, triethylenetetramine, propylenediamine, di(aminomethyl)ether, 1,8-diamino-4-(aminomethyl)octane, xylylenediamine, hydroquinone, bisphenol A, bisphenol sulfone, 1,4-butanedisulfinic acid, benzenedisulfinic acid, thioethanolamine, p-aminothiophenol, and butylenediamine, chitosan, phenolic compounds and formaldehyde, L-lysine, other monomer, oligomeric, or polymeric cross-linking agents known to those of skill in the art, and blends thereof. Typically, a dilute solution comprising the cross-linking agent is first permitted to flow onto the functionalized nanomaterials. Exemplary solvents for the cross-linking agent include water, dimethyl sulfoxide or DMSO, an alcohol (e.g. tetradecanol, pentanol, and) benzyl alcohol, cyclohexane, dichloroethane, heptane, ethyl-2-hexanoic acid, a linear polymer such as polyethylene glycol, supercritical carbon dioxide, etc., and mixtures thereof. In some embodiments, a mix of inert solvents, or a porogenic solvent, may be employed that solvate the polymer chains at least during the early stages of polymerization. In some applications, the solvent is substantially free of water.

After deposition of the cross-linking agent and removal of any solution from deposition of the cross-linking agent, the water absorbing polymer precursor (e.g., non-functionalized acrylamide or a precursor thereof (e.g., acrylic acid)) can be dissolved in or mixed with the nanomaterials in a (volatile or non-volatile) strongly or weakly polar inert solvent. As will be appreciated, before cross-polymerization the acrylamide monomer can alternatively be in the form of an oligomer or polymer (e.g., as a low, medium, or high molecular weight polyacrylamide). The concentration of the acrylamide polymer or oligomer typically ranges from about 10 to about 75 wt. %, more typically from about 15 to about 65 we. %, and even more typically from about 25 to about 55 wt. %. Typically, the hydrogel cross-linking agent is weakly soluble or substantially insoluble in the inert solvent such that the PAM forms on the nanomaterials at deposition locations of the hydrogel cross-linking agent. Exemplary solvents include water, dimethyl sulfoxide or DMSO, an alcohol (e.g. tetradecanol, pentanol, and) benzyl alcohol, cyclohexane, dichloroethane, heptane, ethyl-2-hexanoic acid, a linear polymer such as polyethylene glycol, supercritical carbon dioxide, etc., and mixtures thereof. In some embodiments, a mix of inert solvents, or a porogenic solvent, may be employed that solvate the polymer chains at least during the early stages of polymerization. In some applications, the solvent is substantially free of water. One or more initiators and/or catalysts, such as ammonium persulfate and potassium persulfate (initiator), tetramethylenediamine, β-Dimethylaminopropionitrile and transition metal ions (accelerator otherwise called catalyst), among others can be mixed into the solution or pre-attached to the nanomaterials to assist in cross-polymerization.

The cross-linking agent coated nanomaterials are thoroughly mixed or blended in agitated vessel with the polyacrylamide solution to form a polymerization solution. One or more initiators and/or catalysts, such as ammonium persulfate and potassium persulfate (initiator), tetramethylenediamine, β-Dimethylaminopropionitrile and transition metal ions (accelerator otherwise called catalyst), among others can be mixed into the polymerization solution or pre-attached to the nanomaterials to assist in cross-polymerization. In response, the acrylamide is solvent polymerized to form a cross-linked polymeric framework comprising the cross-linked polyacrylamide encapsulating and surrounding the nanomaterials.

In yet another embodiment, the optional nanomaterials are heat treated in the absence of air with ammonia gas to functionalize the fiber surface with NH₂ (amide groups). The functionalized fiber surface may then be used to first immobilize the sorptive component, a catalyst, an initiator, or a crosslinking agent. Non-limiting examples of suitable initiators and crosslinking agents that can be used in the practice of the present disclosure include: N,N′Bisacrylamide, N,N′-BIS(ACRYLOYL)-CYSTAMINE, ethylenediamine, 1,3-propanediamine, 1,3-propanedithiol, dithiothreitol, dithioerythritol, 1,5-pentanediamine, hexamethylenediamine, diethylenetriamine, triethylenetetramine, propylenediamine, di(aminomethyl)ether, 1,8-diamino-4-(aminomethyl)octane, xylylenediamine, hydroquinone, bisphenol A, bisphenol sulfone, 1,4-butanedisulfinic acid, benzenedisulfinic acid, thioethanolamine, p-aminothiophenol, and butylenediamine. (crosslinking agents), Ammonium persulfate, Potassium Persulfate (initiator) Tetramethylenediamine (accelerator otherwise called catalyst), transition metal ions can also act as catalysts.

It will be evident to those skilled in the art that due to the rough and high surface area nature of graphitic and carbonaceous surfaces, and the availability of sp² electrons upon heating, such surfaces may be used as anchors for either components, catalysts, initiators, or crosslinking agents for the in situ formation of the desired gels. These activated sites can now be used to attach, or immobilize, the hydrogels on a molecular level to the composite porous dehumidifying nanomaterial, commonly a porous graphitic structure.

There is more than one way to immobilize the hydrogels to the nanomaterial. Non-limiting examples of which include:

Using a monomer of the hydrogel in aqueous solution wherein the graphitic nanomaterial is immersed and the hydrogel polymerized in situ with various techniques known in the art, such as radical polymerization. A suitable radical polymerization initiator and a catalyst for the radical polymerization can be selected from the groups of known radical polymerization initiators and catalysts. Preferable radical polymerization initiators and preferable catalysts are those that are water soluble and those that can be substantially homogeneously dispersed in water. Non-limiting examples include a water soluble peroxide, such as potassium peroxidisulfate and ammonium peroxidisulfate; water soluble azo compounds non-limiting examples of which include azo-bis-isobutyrate imidazoline hydrochloride (commercially available as VA-044), 2,2′-azobis(2-methylpropionamidine)-dihydrochloride (commercially available as V-50), both of which are available from and from Wako Chemicals Co. Ltd, and 4,4′-Azobis(4-cyanovaleric acid) which commercially available as V-501 from Sigma-Aldrich, was well as various other water soluble radical initiators having poly(ethylene oxide) chains.

Non-limiting examples of catalysts suitable for use herein include N,N′,N′-tetramethylethylenediamine and β-Dimethylaminopropionitrile. The polymerization temperature is optionally set to a range of 0° C. to 100° C. in conformity with the selected initiator and catalyst, and which is within the skill of those having ordinary skill in the art. The polymerization time, also, will vary with the type of catalyst and initiator and polymerization conditions such as the amount of polymerizing solution (concentration), and the polymerization time periods are within a few seconds to hours. A common method of carrying out the polymerization is to make an aqueous solution of the hydrogel monomer, add an initiator to the solution, and then add the catalyst. The nanomaterials would be immediately immersed in this solution, such that polymerization takes place on the surfaces of the nanomaterial.

2) Using the polymer in aqueous solution, the hydrogel can be crosslinked while the graphitic nanomaterial is immersed in the solution. The crosslinking agent can be any suitable crosslinking agent for the particular polymer being immobilized. Crosslinking agents suitable for any particular hydrogel are well known in the industry. A typical crosslinking agent used for crosslinking thermogels is N,N′-methylene bisacrylamide (BIS). In a common embodiment of the present disclosure, the crosslinked hydrogel can be immobilized on the thermally and electrically conductive graphitic nanomaterial as follows:

The nanomaterial is immersed in the crosslinking agent solution via an incipient wetness method, which is well known in the art. The solution volume is sufficient to “soak” the graphitic nanomaterial, without and flow of the aqueous solution out of the fiber. The concentration of the crosslinking agent is maintained at stoichiometric amounts required to achieve the final polymer. The temperature, pH and pressure is maintained at the known conditions for the formation of the particular hydrogels.

A solution of the hydrogel polymer is prepared and the functionalized graphitic nanomaterial, with crosslinking agent is immersed in the solution. A final crosslinked polymer is formed in-situ on the nanomaterial. A water rinse can be used to eliminate any excess hydrogel that is not crosslinked in an interpenetrating manner with the nanomaterial.

3) Another means to immobilize the hydrogel onto the optional nanomaterial is to prepare a solution of the hydrogel in water and deposit the solution on the graphitic nanomaterial via a suitable incipient wetness technique. After the hydrogel is loosely deposited on the nanomaterial, an alumina sol solution is prepared and the nanomaterial immersed in the solution. The alumina sol gel will fix the hydrogel to the felt fibers.

Other step-growth, condensation, addition, or chain-growth polymerization techniques may be employed, including without limitation emulsion polymerization (e.g., microchannel chip technique, drop break-off technique, and membrane emulsification), solution polymerization, suspension polymerization, dispersion polymerization, and jet polymerization.

In any of the above techniques, the cross-linked graphitic nanomaterial may be in the form of a consolidated mass or large particulate and require comminution or size attrition to form free-flowing smaller (e.g., powder-sized) particles for affixing to the porous substrate.

To avoid forming a consolidated mass, another technique applies a dilute solution of the cross-linking agent, such as by immersion of the nanomaterial in the solution or spraying the solution onto the graphitic nanomaterial. The wetted nanomaterial is permitted to dry and the nanomaterial spread out to form a thin layer on a planar surface. A dilute solution of the acrylamide is sprayed onto the spread nanomaterial such that cross-linking occurs on the nanomaterial.

The cross-linked nanomaterial can then be adhered to the porous substrate by known techniques, such as spin and dip coating methods, the Langmuir-Blodgett method, solvent evaporation, doctor blade, transfer printing, ands using an electrically conductive adhesive applied continuously or discontinuously across the substrate. Electrically conductive adhesives (ECAs) are glue-like materials that are used to create electrical continuity and mechanical connections between components in electronics and microelectronics. ECAs are made up of a conductive component that's suspended in a sticky or adhesive component. The conductive component is made up of particles that are in contact with each other, allowing for the flow of electricity. The most common metal used for the conductive component is silver, which is cost-efficient and has low resistance. Other metals that are commonly used include copper, gold, nickel, aluminum, and graphite. The electrical characteristics of the adhesive should be similar to the electrical characteristics of the graphitic nanofibers and substrate to avoid heat generation caused by differences in electrical resistivity at the different material interfaces and consequent emissions of volatile organic compounds and other undesirable vapors. Graphite-containing ECAs are thus typically employed. Masking may be used to deposit the adhesive selectively in desired locations but not in other portions of the surface of the substrate. In other words, the cross-linked nanomaterials are deposited discontinuously over the surface to provide room for the hydrogel to swell due to water adsorption. Typically, the nanomaterials are dispersed substantially uniformly but discretely over the substrate surface. Affixing the nanomaterials too densely in a given area of the substrate surface can clog the substrate (and cause channeling) in response to hydrogel swelling from moisture capture while having too low a density of nanomaterials can adversely impact levels of moisture capture from air flowing through the substrate.

While a hydrogel may be affixed to the substrate itself, the substrate of the present disclosure itself is typically substantially free of hydrogel prior to deposition of the nanomaterials and, apart from the surface deposited nanomaterial-containing hydrogel, is typically substantially free of hydrogel after nanomaterial deposition.

In another variation of the incipient wetness technique, the cross-linking agent is applied to the nanomaterial, the cross-linking agent carrying nanomaterial is immersed in a very dilute solution of the acrylamide monomer to form a slurry. The slurry is then passed through the substrate, which acts like a filter to pass the solution but retain most of the now cross-linked nanomaterials.

In yet another variation, the cross-linking agent is applied to the nanomaterial and the cross-linking agent carrying nanomaterial applied to the substrate by any technique. The dilute solution of the acrylamide monomer can then be sprayed onto all or only selected portions of the substrate to deposit the cross-linked nanomaterials discontinuously over the substrate surface.

In either of the foregoing techniques, the cross-linked polyacrylamide can adhere to the substrate surface in the absence of an adhesive. An advantage of these techniques over those using an adhesive is that the cross-linked nanomaterials can be dispersed throughout a selected three-dimensional volume of the substrate while the adhesive deposition will typically be limited to an exterior or outer surface and unable to affix cross-linked nanomaterials in the internal volume between the opposing outer surfaces of the substrate.

As will be appreciated, other techniques can be employed to fix the cross-linked nanomaterials to the substrate.

While the above techniques are described in connection with the use of a graphitic nanomaterial, it is to be understood that the techniques may be practiced without the nanomaterial being used in the formulation. The hydrogel material can be applied directly to the substrate rather than first being deposited on the nanomaterials, which are then adhered to the substrate as noted above. When the hydrogel material is applied directly to the substrate, the crosslinking agent, initiator, and/or catalyst can be first be deposited on the substrate surface using any of the techniques discussed herein in connection with nanomaterials.

The above methods of preparation can be in the form of a sheet, or mat, of porous fibrous thermally/electrically conductive substrate supporting hydrogel-containing nanomaterials that is similar in size to the media used for air filtration in HVAC systems. For example, an air conditioner unit can contain a pair of Plate type air filters each containing a composite porous dehumidifying material as filters. These filters are positioned at the air input of the air conditioner unit. One filter will be in a moisture absorption mode while the other is in the regeneration mode after and giving up absorbed water as result of a predetermined external stimulus.

### Regeneration of the Composite Porous Dehumidifying Composite Material

In embodiments, the dehumidifying composite material can be regenerated through various methods. After absorbing water, the material is capable of releasing at least a fraction of the absorbed water upon being subjected to an external stimulus. The external stimulus is selected from a temperature change, pH change, electric field, light intensity and wavelength, pressure change, and ionic strength change.

At least most of the water can be released from the material, commonly at least about 50%, at least about 75%, at least about 85%, at least about 90%, at least about 95%, at least about 99%, or at least about 99.9% of the water.

While the present disclosure focuses on heat, it is to be understood that any method known to the art to subject the material to external stimulus to release water which can be, but is not limited to, pH change, electric field, light intensity and wavelength, pressure change and ionic strength change, can be applied.

In embodiments, the material can be regenerated for repeated use by loading the material into a container that fits inside of a heating jacket. The thermal jacket can then be heated to or just above the LCST to desorb the water to reuse the material. The method of heating can be any method to uniformly heat the material to desorb the water. Optionally, the water released from the material can be collected.

Water can be removed from the beads by application of an external stimulus, such as a temperature change (e.g., heating), pH change, electric field, light intensity and wavelength, pressure change, and ionic strength change. In a typical embodiment, the macro-porous beads are regenerated electrically by periodically passing an electric current, via an embedded electrode, through the bed of macro-porous beads. The electrical current causes the polyacrylamide to desorb the adsorbed water, which will collect, under the force of gravity, in a lower portion of the bed such that the collected water can be removed from the bed by a drain.

It is to be understood that any method of heating the materials and any equipment known to the art can be used to regenerate the materials presently disclosed.

A number of illustrative implementation examples will now be discussed.

### Example 1

In a first implementation example, the substrate is provided with electrodes on two opposite edges. Such electrodes can be attached physically (for example nickel plated copper strips) or can be plated on the edge of the porous and permeable substrate by either electroplating or by electroless plating with nickel. The electrodes can then be connected to a suitable electrical switch that is in electrical communication with an air conditioning unit. The electrical current flows through the substrate and, due to the conductivity of the nanomaterials, through the nanomaterials to expel absorbed moisture and regenerate the hydrogel. Typically, there are two such hydrogel porous substrates in series. When one substrate is exhausted, it would be subjected to an electrical current to start the regeneration stage. In the meantime, moist air would continue to be sucked through it with no effect, since the hydrogel will be in regeneration mode, but the air can be dehumidified by the second substrate. The water obtained from the regeneration of each porous substrate will be collected or drained appropriately. These hydrogel-porous media can be configured with different OEMs to match their HVAC unit sizes and will preferably be placed on the suction side of an air conditioning unit. Negligible pressure loss will result.

A control feedback circuit controls air flow and performs regeneration of the composite porous dehumidifying material. The control feedback circuit comprises the composite porous dehumidifying material, a device to cause air flow in response to a differential pressure, an upstream hygrometer or other relative humidity sensor to measure the humidity of the ambient air, an upstream ambient air temperature sensor (such as a negative temperature coefficient (NTC) thermistor, a resistance temperature detector (RTDs), thermocouple, or semiconductor-based temperature sensor), and a controller (comprising a microprocessor and memory containing a lookup table mapping the measured parameters (e.g., air temperature and humidity) against associated unit operations (e.g., air flow rate).

The controller could control the air flow through the composite porous dehumidifying material to realize a selected humidity in the outputted air to provide a desired level of comfort cooling. This can be done using the measured temperature and relative humidity the controller can determine an amount of water in the air and based on an amount of water to be removed by the composite porous dehumidifying material, adjust the air flow through the composite porous dehumidifying material to realize a relative humidity and air temperature set point in the outputted air. Regeneration cycles in which the air flow stops, and an electric current is passed through the composite porous dehumidifying material to remove adsorbed water can be performed periodically (e.g., at fixed time intervals) or in response to a determination of the cumulative amount of humidity (or water) removed by the material in response to the measured air flow rate as a function of time. The amount of removed water can be compared by the lookup table against a selected water removal capacity of the composite porous dehumidifying material such when the amount of removed water reaches the selected water removal capacity a regeneration cycle is performed.

A downstream relative humidity sensor measures the humidity of the outputted air to evaluate when the composite porous dehumidifying material requires regeneration. When the humidity of the outputted air rises above a selected level, the composite porous dehumidifying material is deemed to have adsorbed its capacity of water, and a regeneration cycle is performed.

The adsorption-desorption technology can provide for storage of energy, to be used either for heating and/or cooling. The macro-porous bead water adsorption technology offers manifold applications in various domains of cooling, heating, and dehumidification. The dehumidifying material can use waste heat from a condenser side of a cooling system can provide the thermal energy required for moisture desorption, thereby minimizing energy requirements for the desorption cycle. Any equipment known to the art can be used to store energy.

### Example 2

In a second implementation example, a dehumidification system includes a housing comprising an interior volume and an input for moist air and an output for dehumidified air and a plurality of plates positioned side-by-side in the interior volume of the housing. Each of the plurality of electrically conductive plates includes at least one layer of a hydrogel-containing material. The hydrogel-containing material comprises (typically electrically conductive) nanomaterials having immobilized thereon a reversible hydrogel that is capable of absorbing water by forming bonds with water molecules and of releasing at least a fraction of the absorbed water upon being heated above a critical temperature.

In water adsorption mode of the dehumidification system, moist (e.g., water-containing) air is introduced through the input into the interior volume, thereby contacting the hydrogel-containing material on the plates. The hydrogel in the hydrogel-containing material will absorb, typically at least about 25%, more typically at least most, and more typically at least about 75% of the water in the air to provide dehumidified that is discharged through the output. When a difference between a sensed parameter, such as the relative humidity, air flow rate, and/or temperature, in the moist input air and dehumidified output air is at least a predetermined value, the flow of the moist input air through the input is stopped and the device enters a regeneration mode in which the hydrogel in the hydrogel-containing material is subjected to an external stimulus, such as a temperature change, pH change, electric field, light intensity and wavelength, pressure change and ionic strength change, to cause desorption of the adsorbed water from the hydrogel and reverse the hydrogel to an unswollen or contracted state in which most of the previously adsorbed water is desorbed or deliquesced. The desorbed water is directed by the collectors positioned at a bottom of the plates to a containment vessel for disposal.

To manufacture the hydrogel-containing material for use in the dehumidification system, an aqueous solution comprising a water-soluble hydrogel precursor, such as an acrylamide monomer or polyacrylamide oligomer or polymer, is prepared. A hydrogel cross-linking agent is deposited on the electrically conductive nanomaterials. The nanomaterials with pre-deposited hydrogel cross-linking agent are added to the aqueous solution and mixed thoroughly. The hydrogel precursor begins cross-linking with the cross-linking agent at the pre-deposited locations.

During cross-polymerization (and before the cross-polymerized hydrogel is too solidified) the polymerization solution can be contacted with the conductive plates by any suitable deposition technique, such as sol gel deposition (in which the polymerization solution or “sol” forms both a liquid phase and solid phase whose morphologies range from discrete particles to continuous polymer networks followed by removal of the liquid phase, such as by a drying process), spin coating (in which the liquid polymerization solution is spread onto the conductive plate by spinning at high speed, resulting in a substantially uniform thin film), spray coating (in which the polymerization solution is sprayed onto the surface of the conductive plate), chemical solution deposition (CSD) (in which a solid phase material layer is formed from a liquid precursor or polymerization solution, effectively “growing” the material layer by layer through chemical reactions within the solution, often at relatively low temperatures compared to other deposition methods), dip coating (in which the conductive metal plate is immersed in the polymerization solution, allowing the polymer to adhere to the plate surface as it is withdrawn), and other thin and thick film deposition techniques to form the layer comprising the nanomaterial and cross-linked hydrogel polymer.

The dehumidification system can be positioned upstream of air conditioning equipment to improve air conditioning performance. The dehumidification system can reduce the energy consumption of an air cooling or air conditioning device by pre-treating the air to be conditioned with a universally applicable water extraction device that can reversibly extract water from a moisture laden air source, at ambient temperatures up to the LCST of the hydrogel used, and at high space velocities sufficient to satisfy commercial HVAC equipment air flow rates. The extraction media can perform without using any significant amount of energy for regeneration. As is well known in the field of HVAC and air conditioning, humidity reduction in ambient air reduces the energy required for conditioning the air for comfort and process. In some applications, the dehumidification system's use of electrically conductive nanomaterials having immobilized hydrogel polymer utilized for water extraction is regenerable by use of waste heat generated by the air conditioning or cooling mechanism.

The dehumidification system of the present disclosure is substantially different from conventional dehumidification systems. Conventional methods of air conditioning and dehumidification, such as compression and the use of desiccants, are inefficient and cause copious amounts of unnecessary greenhouse gas emissions. The system of the present disclosure relates to the use of reversible hydrogels. A critical difference between the hydrogel system of the present disclosure and a desiccant system is that in order for the hydrogel to disgorge the liquid trapped in its network, it needs to be subjected to only a small external stimulus, such as being heated to only a temperature slightly above it's critical point, not to the boiling point of water, as is the case with desiccants. The hydrogel undergoes a rapid and reversible, discontinuous phase transition by collapsing and disgorging liquid water. On the other hand, a desiccant absorbs water vapor and traps it as a liquid, but can only be regenerated by driving the liquid water off as vapor, by creating a high vapor pressure zone on the surface of the desiccant with relation to the surrounding air vapor pressure, thus releasing moisture to the heated, low relative humidity air of regeneration. The hydrogel system of the present disclosure, by contrast, traps water vapor by actually forming hydrogen bonds and polar interactions, reacting with the vapor, and acting as a liquid. During regeneration, the hydrogel disgorges liquid water without requiring any phase change of water. The energy savings in this manner and the reduced load on the air conditioning system for cooling the dehumidified air can be very significant.

The composite porous dehumidifying material can reduce the energy consumption of an air cooling or air conditioning device by pre-treating the air to be conditioned with a universally applicable water extraction device that can reversibly extract water from a moisture laden air source, at ambient temperatures up to the lower critical solution temperature (LCST) of the hydrogel used, and at high space velocities sufficient to satisfy commercial HVAC equipment air flow rates. The extraction media should perform without using any significant amount of energy for regeneration. As is well known in the field of HVAC and air conditioning, humidity reduction in ambient air reduces the energy required for conditioning the air for comfort and process. The composite porous dehumidifying material having immobilized hydrogel polymer utilized for water extraction can also be regenerable by use of waste heat generated by the air conditioning or cooling mechanism. Its performance is repeatable for multiple cycles, the number of which can be determined on commercial evaluations of the intended device.

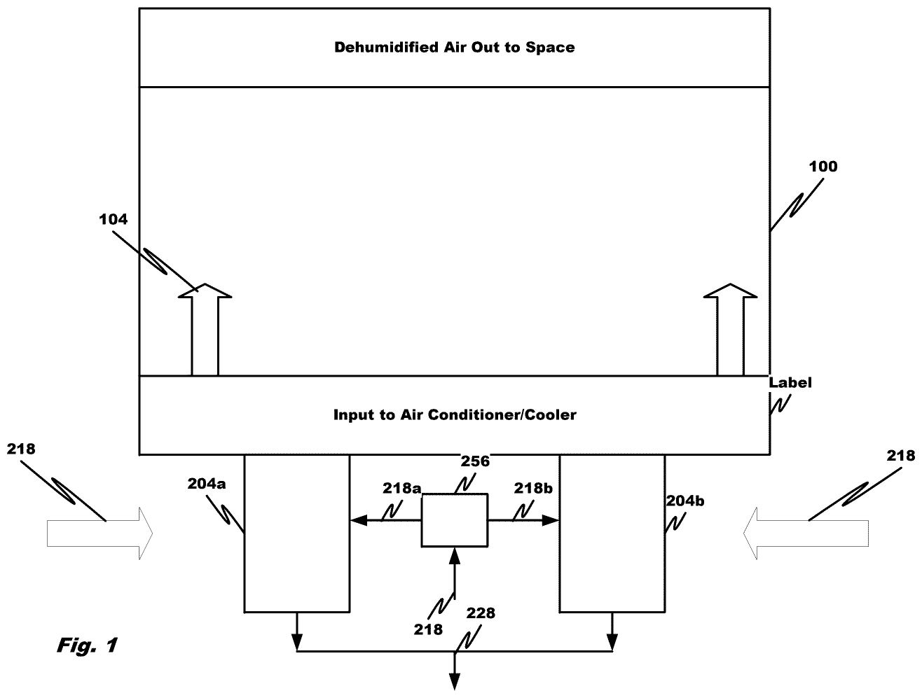

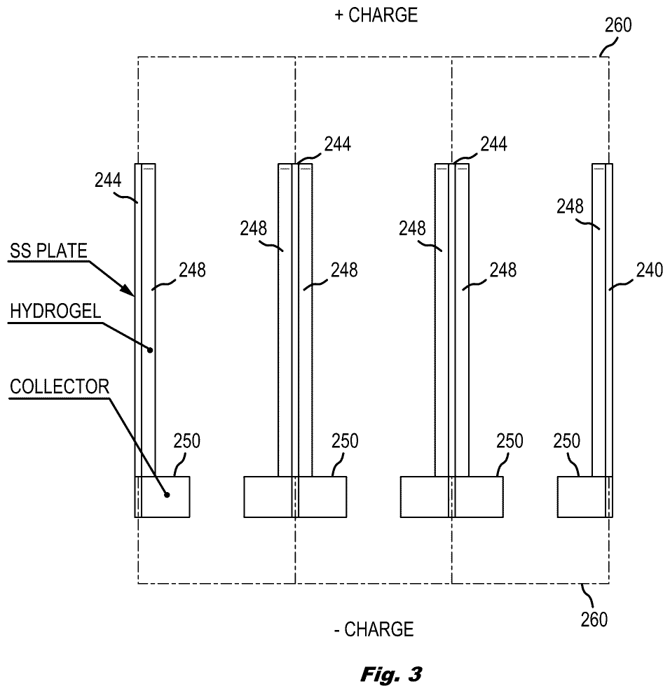

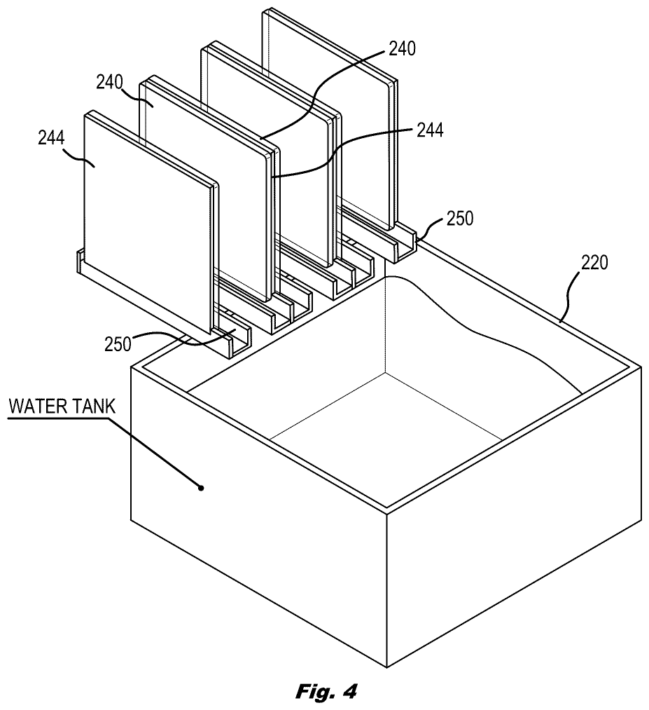

An exemplary implementation of the dehumidification system is shown in FIGS. 1-4.

Referring to FIG. 1, first and second dehumidification devices 204 are positioned upstream of an air conditioner or air cooler 100 to dehumidify moist air 218 to provide dehumidified air 104 to the air condition or air cooler 100 for cooling. The dehumidification devices can be configured with different OEMs to match their HVAC unit sizes and will preferably be placed on the suction side of an air conditioning unit. Negligible pressure loss will typically result.

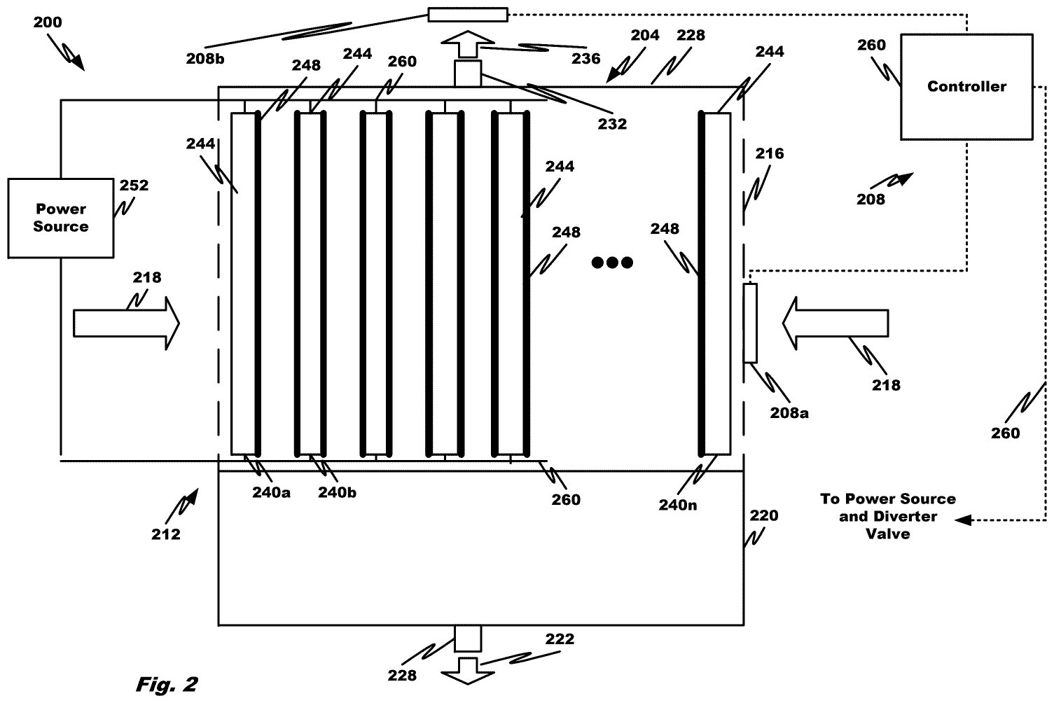

Referring to FIGS. 2-4, the dehumidification system 200 includes a dehumidification device 204 and a control system 208.

The dehumidification device 204 comprises a housing 212 that includes a porous and permeable sidewall 216 (that may be configured as a filtration medium to remove particulates from the air stream 218), a water impervious collector 220 to capture desorbed water 222 from the hydrogel-containing material for discharge through on outlet 224, a top surface 228 comprising an outlet 232 for dry air 236 and a plurality of water adsorbing plates 240a-n enclosed by the housing 212. Each of the water adsorbing plates 240a-n comprises a conductive plate 244 comprising one or more layers 248 of the hydrogel-containing material. A collector 250 is positioned at a lower end of each of the water adsorbing plates 240a-n to capture discharge desorbed water into the water impervious collector 220 or water tank.

The conductive plate 244 can be any electrically conductive material, such as a metallic material (e.g., silver, copper, aluminum, iron, steel, stainless steel, brass, and zinc), semiconductor, nonmetallic conductor such as graphite and conductive polymers, and other electrical conductors.

The hydrogel in the hydrogel-containing material in the layers 248 can include any suitable hydrogel. The reversible hydrogels commonly undergo discontinuous volume phase transition behavior. The hydrogel can be comprised of a single polymer that meets both the sorptive and regenerative requirements. The hydrogel will typically collapse by giving up at least a fraction of water absorbed under a trigger environmental condition, such as a specific range of temperature, for example a temperature range of about 60° to 80° C., and expands to up to about 400% of its original volume under a second trigger environmental condition, such as ambient temperature of about 15° to 50° C.

The hydrogel-containing material in the layers 248 further includes a nanomaterial to provide sufficient strength to maintain structural integrity after repeated cycles of swelling and collapse of the hydrogel and to impart electrical conductivity for hydrogel regeneration in such cycles. The nanomaterial is primarily comprised of electrically conductive nanomaterials, which are typically graphitic. The nanomaterials include electrically conductive carbon nanoparticles and nanofibers. Regarding properties, graphitic nanoparticles can exhibit unique properties such as high surface area, quantum confinement effects, and size-dependent optical and electronic properties. In some embodiments, the nanoparticles are in the form of nanofibers that consist primarily or entirely of crystalline graphite. The crystalline graphite can be of different forms. In some embodiments, the nanofibers primarily or entirely consist of platelet-type carbon nanofibers, in which the nanofibers comprise platelets that are aligned perpendicular to a major axis of the nanofiber. In some embodiments, the nanofibers primarily or entirely consist of herringbone nanofibers in which the graphene layers are stacked obliquely with respect to the major axis of the nanofiber. In some embodiments, the nanofibers primarily or entirely consist of ribbon nanofibers in which the graphene layers are substantially parallel to the major axis. The various types of nanofibers may be mixed together in various ratios depending on the application.

Typically, the reversible hydrogel-containing material on the conductive plate 244 is in a form so thin that the absorbed water has very little distance to travel to the inner part of the hydrogel. The thickness of the hydrogel layer will typically be from about 0.01 to 1000 microns, typically from about 1 to 500 microns, more typically from about 10 to 250 microns, and even more typically from about 100 to about 200 microns.

Referring again to FIGS. 2-4, the control system 208 can include one or more sensors 208a and b, a power source 252, a diverter valve 256 (FIG. 1), and a controller 260 via the dashed control lines 260. The one or more sensors 208a and 208b measure one or more of the relative humidity (e.g., such as a hygrometer, wet and dry bulb thermometer, and psychrometer), temperature (e.g., such as a thermometer, thermistor, thermocouple, and air probe), and airflow (e.g., such as an anemometer, air flow meter, venturi meter, orifice plate, dall tube, balometer, and thermistor). The power source can be any low power source, such as a low voltage and low current battery, small solar cell, and energy harvesting device. The diverter valve can be any electrically controllable or actuatable valve that controls the flow of a liquid or gas, allowing the user to redirect it from a first path to a second path and vice versa.

The operation of the dehumidification system 200 will now be described with reference to FIGS. 1-4. As shown in FIG. 1, first and second dehumidification devices 204a and b are positioned at an input and in fluid communication with the air conditioner or cooler 100. One device 204a is in a water adsorption mode while the other is in the regeneration mode after completing a moisture adsorption cycle and giving up adsorbed water due to application of a predetermined external stimulus.

During the water adsorption mode, moist air 218 passes through the porous and permeable sidewall 216 and contacts the layers 248 of hydrogel-containing material on the conductive plates 244. The hydrogel in the hydrogel-containing material adsorbs at least most of the moisture from the moist air and provides dehumidified or dry air 236 to the air conditioner or cooler input. During the water adsorption mode, the controller 260 determines comparative humidity by comparing the relative humidity, absolute humidity, temperature, and/or flowrate from the first one or more sensors 208a against the relative humidity, absolute humidity, temperature, and/or flowrate from the second one or more sensors 208b. When the comparative humidity is at least a predetermined value, the controller terminates the water adsorption mode and causes the diverter valve 256 to divert the moist from a first flow path to the first dehumidification device 204a to a second flow path to the second dehumidification device 204b, which exits the regeneration mode and reenters the water adsorption mode.

In the regeneration mode, the controller 260 applies a small current via conductors 260, which conveys the current to the conductive plates 244, which in turn conveys the current to the electrically conductive nanomaterials in the hydrogel-containing material 248, thereby causing the hydrogen-containing material 248 to heat up above the hydrogel's LCST, a point at which the phase transition network of the reversible hydrogels collapses, and there is severe contraction. In response, the reversible hydrogel in the hydrogel-containing material deliquesces and releases the absorbed water. The typical hydrogel can disgorge the liquid trapped in its network in response to only a small external stimulus, such as being heated to only a temperature slightly above its critical point. The hydrogel undergoes a rapid and reversible, discontinuous phase transition by collapsing and disgorging liquid water. During regeneration, the hydrogel disgorges the liquid water without any phase change of water. The desorbed water obtained from the regeneration of each layer of hydrogel-containing material is collected in the appropriate collector, discharged into the water tank, and drained appropriately. Alternatively, hydrogel regeneration can be done by another external stimulus, such as a temperature change (e.g., heating), pH change, electric field, light intensity and wavelength, pressure change, and ionic strength change.

### Example 3

In yet another implementation example, the composite porous dehumidifying material extracts potable water from air for human consumption. By way of illustration, a solar powered water dispenser comprises the composite porous dehumidifying material and a device to cause air flow in response to a differential pressure, such as a fan, air compressor, and the like. The passage of air through the composite porous dehumidifying material causes latent moisture to collect on the composite porous dehumidifying material, which is periodically removed from the material by passage of an electric current generated by the solar cells and/or batteries in electrical communication with the solar cells. An air purification unit, such as comprising an activated carbon or zeolite media, can be positioned upstream of the composite porous dehumidifying material to remove airborne contaminants to provide clean water. A demister can be used to remove aerosols or droplets from the inputted air, such as the aerosols or droplets from a nearby saltwater source. It is to be understood that any equipment known to the art can be used.

### Example 4

In yet another exemplary implementation, the composite porous dehumidifying material is used as a filtration unit positioned upstream of an evaporative cooling system to reduce the humidity of the air and thereby increase the efficiency of the evaporative cooling system. The extracted water can be used by the evaporative cooling system to evaporatively cool the air. The size of the evaporative cooling system can thereby be decreased when compared to an evaporative cooling system in the absence of the composite porous dehumidifying material.

The filtration unit can be a column or other suitable configuration. The filtration unit replaces conventional dessicants, typically with a composite porous dehumidifying material in the form of the macroporous resin coated with the reversible hydrogel material. The presence of the conductive nanomaterial is not a requirement. The hydrogel material can be deposited on the surface (and in the pores) of the macroporous resin by techniques described above as a nano thick layer film. The nano thick layer film typically has a thickness ranging from about 0.1 to about 1,000 nanometers, more typically from about 0.5 to about 750 nanometers, and more typically from about 1 to about 500 nanometers. When used as nano film, the strength support provided by the nanomaterials may not be required. When the columnar dehumidification unit is exhausted, the filtration unit may be contacted with a heated insert fluidic medium, such as water or steam, heated to a temperature greater than the hydrogel's critical temperature (e.g., LCST), thereby forcing the hydrogel to release the water. The released water and fluidic medium are collected and drained from the filtration unit.

When a thermally conductive material is used as the substrate, the filtration unit can include a jacketed column and hydrogel regeneration may be effected via hot water in the jacket. The requisite thermal conductivity is not required to be very high.

The parallel plate configuration of FIGS. 1-4 may not be the preferred design in many applications. The columnar filtration unit configuration beneficially provides the ability to replace conventional desiccant columns in the field, and, if water recovery is not desired, energy consumption may be significantly reduced by passing warm air over the hydrogels, thereby obviating the need for latent heat.

### Example 5

Other embodiments of this disclosure relate to an air conditioning unit, or chiller, which incorporates the use of the water-adsorbing macroporous resin in a HEPA type filter. In HVAC applications, the macro-porous beads can replace zeolite in conventional HVAC systems and typically have a bead size ranging from about 0.5 to about 25 mm and more typically from about 1 to about 10 mm.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, sub combinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate common embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A dehumidifying material, comprising an electrically conductive nanomaterial intermixed with a reversible hydrogel material that is capable of absorbing water by forming bonds with water molecules from moisture-containing air and of releasing at least a fraction of the absorbed water upon being subjected to an electrical current.

2. The material of claim 1, wherein the electrically conductive nanomaterial and reversible hydrogel material is supported on a porous substrate, wherein the electrically conductive nanomaterial is dispersed throughout the reversible hydrogel material, wherein the electrically conductive nanomaterial comprises a graphitic nanomaterial, and wherein the porous substrate is a macroporous, permeable and electrically conductive substrate, the nanomaterial-containing hydrogel being deposited on the substrate.

3. The material of claim 2, wherein from about 0.1 to 50% of the surface of the substrate comprises the nanomaterial intermixed with the reversible hydrogel material, wherein the reversible hydrogel material is immobilized on the surface of the nanomaterial, and wherein the substrate comprises one of a ceramic material and glass-containing material.

4. The material of claim 2, wherein the nanomaterial intermixed with the reversible hydrogel material forms a layer supported by the substrate, wherein the thickness of the layer is from about 0.01 to about 1000 microns, and wherein the substrate comprises one of silicon carbide-containing particles, glass-containing particles, macroporous resin particles, activated carbon particles, graphite-containing particles, graphite and carbon black-containing particles, and combinations and composites thereof.

5. The material of claim 1, wherein the hydrogel is selected from the group consisting essentially of poly(vinyl methyl ethers); N,N-Diethyl acrylamide copolymers; acrylamides (N-alkyl or N-alkalene substituted); methacrylamides, such as poly(methacrylamideopropyl-methoammoniumchlorides); poly(acrylamide), poly(N-methylacrylamide), poly(N-ethylacrylamide), poly(cyclopropylacrylamide), poly(N-isopropylacrylamide), poly(methacrylamide), poly(N-methylmethacrylamide), poly(cyclopropylmethacrylamide), poly(N-isopropylmethacrylamide), poly(dimethylacrylamide), poly(N,N-dimethylaminopropylacrylamide, poly(N-methyl-N-ethylacrylamide), poly(N-methyl-N-isopropylacrylamide), poly(N-methyl-N-ethylacrylamide), poly(N-methyl-N-isopropylacrylamide), poly(N-methyl-N-n-propylacrylamide), poly(N,N-diethylacrylamide) poly(N-acryloylpyrrolidine), poly(N-acryloylpiperidine), poly(N-acryloylmethylhomopiperidine), poly(N-acryloylmethylpiperidine), and poly(N-acryloylmethylpiperidine) and wherein the hydrogen is cross-linked.

6. The material of claim 2, wherein the substrate comprises primarily silicon carbide, wherein the nanomaterial is adhered to a surface of the substrate, and wherein the substrate is a macroporous material that is in the shape of a rod or bead.

7. The material of claim 2, wherein the nanomaterial intermixed with the reversible hydrogel material forms a discontinuous layer supported by the substrate, wherein the layer coats from about 5 to about 85% of the area of the substrate, wherein a thickness of the layer ranges from about 0.01 to about 1,000 microns, wherein the nanomaterial has a surface area ranging from about 5 to about 4,000 m²/g, an average length of about 0.5 to about 10 microns and an average width of about 40 to about 60 nanometers, a thermal conductivity (at 50° C.) between about 0.04 to about 0.8 W/m*° K, and an electrical resistivity (at 20° C.) of from about 200 to about 300 ohm*cm, wherein the layer comprises from about 10 to about 75% wt. nanomaterial, wherein the substrate has a mean, median, and/or mode pore size of at least about 200 microns, a porosity ranging from about 10 to about 60%, a pore volume of from about 0.01 to about 1 cm³/g, and a BET surface area of from about 20 to about 400 m²/g, a thermal conductivity of from about 50 to about 330 W/m*° K, and an electrical conductivity of at least about 0.1×10² S m⁻¹ (at 298-1150 K).

8. A dehumidifying material, comprising a hydrophobic porous substrate having immobilized thereon a reversible hydrogel material that is capable of absorbing water by forming bonds with water molecules from moisture-containing air and of releasing at least a fraction of the absorbed water upon being subjected to a change in temperature.

9. The material of claim 8, wherein the hydrophobic porous substrate comprises activated carbon and wherein the activated carbon comprises a granular activated carbon.

10. The material of claim 8, wherein the hydrogel material is deposited discontinuously over the surface area of the activated carbon.

11. The material of claim 8, wherein the hydrophobic porous substrate comprises graphite and wherein the hydrogel material is deposited discontinuously over the surface area of the graphite.

12. The material of claim 8, further comprising a graphitic nanomaterial, wherein the nanomaterial is intermixed with the reversible hydrogel material to form a layer supported by the substrate, wherein the thickness of the layer is from about 0.01 to about 1000 microns, and wherein the substrate comprises one of silicon carbide-containing particles, glass-containing particles, macroporous resin particles, activated carbon particles, graphite-containing particles, graphite and carbon black-containing particles, and combinations and composites thereof.

13. The material of claim 8, wherein the hydrogel is selected from the group consisting essentially of poly(vinyl methyl ethers); N,N-Diethyl acrylamide copolymers; acrylamides (N-alkyl or N-alkalene substituted); methacrylamides, such as poly(methacrylamideopropyl-methoammoniumchlorides); poly(acrylamide), poly(N-methylacrylamide), poly(N-ethylacrylamide), poly(cyclopropylacrylamide), poly(N-isopropylacrylamide), poly(methacrylamide), poly(N-methylmethacrylamide), poly(cyclopropylmethacrylamide), poly(N-isopropylmethacrylamide), poly(dimethylacrylamide), poly(N,N-dimethylaminopropylacrylamide, poly(N-methyl-N-ethylacrylamide), poly(N-methyl-N-isopropylacrylamide), poly(N-methyl-N-ethylacrylamide), poly(N-methyl-N-isopropylacrylamide), poly(N-methyl-N-n-propylacrylamide), poly(N,N-diethylacrylamide) poly(N-acryloylpyrrolidine), poly(N-acryloylpiperidine), poly(N-acryloylmethylhomopiperidine), poly(N-acryloylmethylpiperidine), and poly(N-acryloylmethylpiperidine) and wherein the hydrogen is cross-linked.

14. The material of claim 8, wherein the substrate comprises primarily silicon carbide, wherein the nanomaterial is adhered to a surface of the substrate, and wherein the substrate is a macroporous material that is in the shape of a rod or bead.

15. The material of claim 8, further comprising a graphitic nanomaterial, wherein the nanomaterial is intermixed with the reversible hydrogel material to form a discontinuous layer supported by the substrate, wherein the layer coats from about 5 to about 85% of the area of the substrate, wherein a thickness of the layer ranges from about 0.01 to about 1,000 microns, wherein the nanomaterial has a surface area ranging from about 5 to about 4,000 m²/g, an average length of about 0.5 to about 10 microns and an average width of about 40 to about 60 nanometers, a thermal conductivity (at 50° C.) between about 0.04 to about 0.8 W/m*° K, and an electrical resistivity (at 20° C.) of from about 200 to about 300 ohm*cm, wherein the layer comprises from about 10 to about 75% wt. nanomaterial, wherein the substrate has a mean, median, and/or mode pore size of at least about 200 microns, a porosity ranging from about 10 to about 60%, a pore volume of from about 0.01 to about 1 cm³/g, and a BET surface area of from about 20 to about 400 m²/g, a thermal conductivity of from about 50 to about 330 W/m*° K, and an electrical conductivity of at least about 0.1×10² S m⁻¹ (at 298-1150 K).

16. A dehumidification system comprising:
a housing comprising an interior volume and an input for moist air and an output for dehumidified air; and
a plurality of plates positioned side-by-side in the interior volume of the housing, each of the plurality of electrically conductive plates comprising at least one layer of a hydrogel-containing material, the hydrogel-containing material comprises electrically conductive nanomaterials having immobilized thereon a reversible hydrogel that is capable of absorbing water by forming bonds with water molecules and of releasing at least a fraction of the absorbed water upon being heated above a critical temperature.

17. The system of claim 16, wherein each of the plurality of plates is electrically conductive and wherein, in a desorption cycle, an electrical current is passed through each of the plurality of plates to cause desorption of water from the hydrogel-containing material.

18. The material of claim 17, wherein a thickness of the at least one layer of the hydrogel-containing material ranges from about 0.01 to about 1000 microns.

19. A dehumidifying macroporous material, comprising a cross-linked polymer and optionally nanomaterials, the material having immobilized thereon a reversible hydrogel macroporous material that is capable of absorbing water by forming bonds with water molecules from moisture-containing air and of releasing at least a fraction of the absorbed water upon being subjected to a suitable stimulus.

20. The material of claim 19, wherein the material comprises embedded nanomaterials, wherein the nanomaterial comprises a graphitic nanomaterial and wherein the macroporous material is not supported by a substrate, and wherein the macroporous material is in the shape of a rod or bead.
